(19) United States
(12) Patent Application Publication
(10) Pub. No.: US 2012/0154440 A1
(43) Pub. Date: Jun. 21, 2012

(54) AUGMENTED 2D REPRESENTATION OF MOLECULAR STRUCTURES

(75) Inventors: Anthony Nicholls, Santa Fe, NM (US); Robert Tolbert, Santa Fe, NM (US); Krisztina Boda, Santa Fe, NM (US)

(73) Assignee: OpenEye Scientific Software, Inc., Santa Fe, NM (US)

(21) Appl. No.: 13/296,074

(22) Filed: Nov. 14, 2011

Related U.S. Application Data
(60) Provisional application No. 61/412,744, filed on Nov. 11, 2010.

(51) Int. Cl. G09G 5/00

(52) U.S. Cl. 345/633

(57) ABSTRACT

A method, computing apparatus, and computer readable medium, for augmenting and displaying a 2D-representation of a molecular structure, or assemblage of molecular structures, augmented with various graphical elements. The technology further provides various functionality that permits a user to define the form and number of types of graphical elements to apply to a 2-D structure.

### CLAIM OF PRIORITY

This application claims the benefit of priority under 35 U.S.C. §119(e) to U.S. provisional application Ser. No. 61/412,744, filed Nov. 11, 2010, which is incorporated herein by reference in its entirety.

### TECHNICAL FIELD

The technology described herein generally relates to methods of displaying information about molecules, and interactions between molecules, in a two-dimensional format, for example, by display on a computer screen, or a screen of a mobile computing device. The technology also provides for a programmable interface for superimposing properties and information of choice onto two-dimensional molecular depictions.

### BACKGROUND

Two-dimensional (“2D”, or “2-D”) structure diagrams can be considered to be the “natural language” of chemists, not least because this graphical representation of structures allows molecules to be instantly conceivable in ways that a name does not, but also because the form maps on to the way that chemists have been trained to think of molecules.

Although the development of sophisticated computer graphics programs over the last several decades has made it easy to display and manipulate (e.g., rotate, scale, or translate) three-dimensional (“3D” or “3-D”) structures of molecules, those depictions often fail to convey at a glance the same quantity of information that can be displayed in 2-D. Thus, as a practical matter, regardless of the amount of training provided to chemists in the use of 3D representations, there is a natural tendency to default to reviewing pages of 2D images of molecules, either as print-outs or on computer displays.

Thus, 2D representations are popular because they give clean, largely unambiguous, information about the chemical composition and connectivity within a molecule. However, 2-D representations are effectively invariant in the chemical literature. In other words, the 2-D representation is a standard that admits to very little modification. In part this is because of the expectations of chemists: the 2-D language is so pervasive that unsystematic departures from it could lead to confusion. It is partly due to the fact that unsystematic departures, where they have been proposed, have not gained a common currency. It is also in part due to the fact that the tools used to generate 2-D chemical structure drawings are not freely open to adaptation. On the one hand, if enhancements to a 2-D drawing are needed, it is necessary either move to a 3-D paradigm, or to add information on top of an extant 2-D drawing, such as with a caption. Conversely, those computer programs that have offered deviations from the traditional 2-D representation have done so in a way that itself cannot easily be modified or adapted.

Historically, 2D representations have mainly been used to visualize the connection table of molecular graphs (i.e., the network of bonds between the atoms in the molecule) in a way that facilitates both recognition of a particular structure as well as comparisons amongst closely similar structures when laid out according to a common scheme or orientation. However, 2D representations are limited in their ability to highlight important aspects of a molecule's actual 3-D configuration that can determine its properties and behavior. Projecting 3D information into a 2D layout, such as by displaying various atom and bond properties on the molecular structure diagram opens up new ways to usefully present information to chemists in a manner that can be interpreted at a glance. However, achieving a representation that truly augments the underlying 2D structure rather than unduly clutters it or obscures it, and does so in a way that is flexible to the user in that a user can choose the style of augmentation as well as the specific properties to accentuate, is not trivial.

Given that the 2D representation provides a vast amount of important information about a molecule's structure with which to conceptualize, it makes sense therefore, to capitalize on this habit amongst chemists and provide 2-D representations that are suitably enhanced to show pieces of information from the 3-dimensional world, as well as to provide a platform on which a user can make constructive choices about the style and quantity of the visual enhancements. In other words, the success of an idea can be determined by whether it is presented in a manner in which the viewer wants to see it.

Related work to this disclosure includes the program LigPlot (see, e.g., “LigPlot: Program for automatically plotting protein-ligand interactions”, A. Wallace and R. Laskowski www.ebi.ac.uk/thornton-srv/software/LIGPLOT/). LigPlot displays information about protein-ligand interactions in 2-D; the ligand is shown in its entirety, and protein receptor residues with which it makes contact are arranged around its periphery. The displays generated by LigPlot differ from a traditional 2D molecular representation in a number of key respects, however. First, the 2-D line drawing is replaced with a ball-and-stick representation in which atoms are color-coded circles, and bonds are colored lines that do not evince the bond order. Second, the attributes that derive from 3-D and which are superimposed on the 2-D framework are shown in only two ways: hydrogen bonds are shown as dashed lines and annotated distances between ligand atoms and specific atoms from a selection of proximate protein receptor residues; hydrophobic interactions are shown by an arc of a circle adorned with spokes that point towards the ligand contact atoms. Those ligand contact atoms are similarly adorned with complementary spokes. Finally, LigPlot does not offer a user any options to go systematically beyond its default style of representation, although individual plots can be manually edited using other computer programs.

Another program is available from within the Molecular Operating Environment of Chemical Computing Group, see www.chemcomp.com/journal/ligintdia.htm. In this approach, a more traditional 2-D chemical structure layout for a ligand is used, but residues around the molecule's periphery are represented by labeled circles and connected to contact atoms on the ligand by arrows. A line surface can be shown, surrounding ligand, either in its entirety or at specific atoms, but this line does not correspond to a solvent-accessible surface for the ligand. See also: www.chemcomp.com/journal/depictor.htm.

Other programs, including for example SZMAP, available from OpenEye Scientific Software, Inc., Santa Fe, N. Mex., provide solvation energies as grids of thermodynamic quantities. However, the displays generated by such programs would benefit from providing a visualization of the individual solvent molecules, i.e., a discrete representation of H₂O molecules rather than a continuum property.

The discussion of the background herein is included to explain the context of the technology. This is not to be taken as an admission that any of the material referred to was published, known, or part of the common general knowledge as at the priority date of any of the claims found appended hereto.

Throughout the description and claims of the specification the word “comprise” and variations thereof, such as “comprising” and “comprises”, is not intended to exclude other additives, components, integers or steps.

### SUMMARY

The instant disclosure addresses the processing of molecular structure data on a computing apparatus to provide visual representations that convey useful scientific information. In particular, the disclosure comprises a process, a suitably configured computing apparatus for carrying out the process, as well as a computer-readable memory encoded with instructions for execution on a computer, to provide the visual representations described herein.

A method of displaying a molecular structure, the method comprising: adding a set of graphical elements to a 2D representation of a molecular structure, thereby creating an augmented representation of the molecular structure; and causing the augmented representation to be displayed to a user, wherein the 2D representation comprises a graph in which each edge in the graph corresponds to a chemical bond in the molecular structure, and each node in the graph corresponds to an atom in the molecular structure, and wherein the set of graphical elements includes one or more elements, such as two or more elements, or three or more elements, or four or more elements, or all five elements, selected from: an accessible surface contour around the graph or a part of the graph; a background shading or color scheme behind the graph or a part of the graph; a highlight applied to a discrete set of nodes and edges in the graph; an atom symbol applied to one or more nodes in the graph; and a bond symbol applied to one or more edges in the graph, wherein each element in the set of graphical elements comprises a selectable style, and at least one parameter having a user-defined value; wherein the method is carried out on a computer.

A computing apparatus, comprising: a processor; a memory; an input; and a display, wherein the processor, memory, input, and display are connected by at least one bus, and wherein the processor is configured to execute instructions for: adding a set of graphical elements to a 2D representation of a molecular structure, thereby creating an augmented representation of the molecular structure; and causing the augmented representation to be displayed to a user, wherein the 2D representation comprises a graph in which each edge corresponds to a chemical bond in the molecular structure, and each node corresponds to an atom in the molecular structure, and wherein the set of graphical elements includes one or more elements, such as two or more, three or more, four or more, or all five elements, selected from: an accessible surface contour around the graph or a part of the graph; a background shading or color scheme behind the graph or a part of the graph; a highlight applied to a discrete set of nodes and edges in the graph; an atom symbol applied to one or more nodes in the graph; and a bond symbol applied to one or more edges in the graph, wherein each element in the set of graphical elements comprises a selectable style, and at least one parameter having a user-defined value.

A computer program product, comprising: a computer readable medium configured with processor-executable instructions for: adding a set of graphical elements to a 2D representation of a molecular structure, thereby creating an augmented representation of the molecular structure; and causing the augmented representation to be displayed to a user, wherein the 2D representation comprises a graph in which each edge corresponds to a chemical bond in the molecular structure, and each node corresponds to an atom in the molecular structure, and wherein the set of graphical elements includes one or more elements, such as two or more, three or more, four or more, or all five elements, selected from: an accessible surface contour around the graph or a part of the graph; a background shading or color scheme behind the graph or a part of the graph; a highlight applied to a discrete set of nodes and edges in the graph; an atom symbol applied to one or more nodes in the graph; and a bond symbol applied to one or more edges in the graph, wherein each element in the set of graphical elements comprises a selectable style, and at least one user-defined parameter.

A computer program product, comprising: a computer readable medium configured with a kit of processor-executable instructions for augmenting a 2D representation of a chemical structure, wherein the kit comprises: instructions for adding an accessible surface contour around the graph or a part of the graph; instructions for adding a background shading or color scheme behind the graph or a part of the graph; instructions for highlighting a discrete set of nodes and edges in the graph; instructions for inserting an atom symbol at one or more nodes in the graph; and instructions for inserting a bond symbol to one or more edges in the graph, wherein the kit is configured to provide control by a user, and the instructions are executed at the choice of the user.

The techniques described herein can be made available to software users in toolkit form so that the users may create utilities appropriate to their customers, e.g., chemists, and may be made available in visualization programs, and may also form the foundation layer for a 3D modeling program that avoids the need for 3D visualization.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows an exemplary calculation of the 2D representation of a molecule surface.

FIG. 2 shows a selection of surface line patterns.

FIGS. 3A and 3B show an exemplary accessible surface. FIG. 3C shows an ‘onion’ form surface.

FIG. 4 shows a molecule with a background color scheme.

FIG. 5 shows a molecule with a highlighted substructure.

FIG. 6 shows the molecule of FIG. 5, with additional bond symbols.

FIG. 7 shows a flavoid-mononucleotide with background coloring indicating solvent effects.

FIGS. 8A and 8B show a 2-D molecule structure with atoms annotated according to various properties.

FIG. 9 shows a 2D chemical structure with rotatable bonds annotated.

FIGS. 10A and 10B show 2D molecular structures annotated with a color-coded molecular surface.

FIG. 11 shows a selection of surface arcs for designating geometric features of a surrounding receptor surface.

FIGS. 12A, 12B, 12C, and 12D show a Trimethoprim a molecule situated in a receptor. In FIG. 12A, surface arcs designate aspects of receptor geometry. FIG. 12B shows surface arcs that designate aspects of receptor geometry and that are scaled to represent distance between molecule and receptor. FIG. 12C shows alternative forms of surface style to designate aspects of the ligand-receptor interaction, annotated with text for clarity herein. FIG. 12D shows the surface forms of FIG. 12C with additional molecular property fields superimposed thereon.

FIG. 13 shows a 2-D chemical structure with a background property map.

FIGS. 14A and 14B show an ensemble of molecules having a background property map to show distributions of partial charges.

FIG. 15 shows a selection of atom symbols.

FIG. 16 shows a selection of bond symbols.

FIG. 17 shows a selection of bond symbols.

FIG. 18 shows a selection of highlights for a molecular substructure.

FIG. 19 shows a table of augmented molecular structures, as might be generated to illustrate a number of different environments for a molecule.

FIG. 20 shows a 2-D molecule structure augmented with an number of different accessible surface styles.

FIG. 21 shows a representative surface arc, with a selection of controlling parameters.

FIG. 22 shows a number of exemplary circle styles, such as for atom symbols.

FIG. 23 shows a number of exemplary arc styles, such as for accessible surfaces.

FIGS. 24A and 24B compare inwardly and outwardly point patterns on circles and arc.

FIGS. 25A and 25B show aspects of parameterization of the “brick road” circle and arc style.

FIGS. 26A and 26B show aspects of parameterization of the “castle” circle and arc style.

FIGS. 27A and 27B show aspects of parameterization of the “cog” circle and arc style.

FIGS. 28A and 28B show aspects of parameterization of the “eye lash” circle and arc style.

FIGS. 29A and 29B show aspects of parameterization of the “flower” circle and arc style.

FIGS. 30A and 30B show aspects of parameterization of the “necklace” circle and arc style.

FIGS. 31A and 31B show aspects of parameterization of the “olive branch” circle and arc style.

FIGS. 32A and 32B show aspects of parameterization of the “pearls” circle and arc style.

FIGS. 33A and 33B show aspects of parameterization of the “race track” circle and arc style.

FIGS. 34A and 34B show aspects of parameterization of the “railroad” circle and arc style.

FIGS. 35A and 35B show aspects of parameterization of the “saw” circle and arc style.

FIGS. 36A and 36B show aspects of parameterization of the “Simpson” circle and arc style.

FIGS. 37A and 37B show aspects of parameterization of the “stitch” circle and arc style.

FIGS. 38A and 38B show aspects of parameterization of the “sun” circle and arc style.

FIGS. 39A and 39B show aspects of parameterization of the “wreath” circle and arc style.

FIGS. 40A and 40B show aspects of parameterization of the “alpha rainbow” circle and arc style.

FIG. 41 show aspects of parameterization of the “alpha rainbow” circle style.

FIG. 42 shows the superposition of a surface drawn for a reference molecule, onto the 2-D structure of a second molecule.

FIGS. 43A and 43B show a shape overlap function superimposed on an accessible surface contour.

### DETAILED DESCRIPTION

The instant technology is directed to methods, computing apparatus, and computer-readable media configured to provide a user with a useful 2D visualization of molecular structures and interactions between molecular structures, e.g., between on the one hand ligands such as small organic molecules, peptides, and small proteins, and on the other hand receptors such as protein surfaces, clefts, and protein binding sites, enzyme active sites. The technology further provides an ability to display solvent molecules such as water molecules, as well as, where present, third molecules such as co-activators, co-repressors, and co-enzymes, and the nature of interactions between such molecules and the ligand and protein.

One purpose of the technology is to put additional information, in particular that derived from 3D, into the familiar 2D line drawings that have dominated chemistry for over a hundred years, but in a manner that is governed by user choice as to form and style of representation, and which is clear to visualize, and which does not detract from or obscure the underlying 2D representation. Such additional information will be referred to herein as an augmentation, or as augmentations, to the underlying 2D representation. The 2D representation, having one or more augmentations applied to it, will be referred to as an augmented representation, or as an augmented 2D representation.

One significant value of the augmented 2D representations described herein is to aid in molecular design. In structure-based projects, there is often good information as to the alignment of the molecule being represented in an active site of a biomolecule such as a protein. In such projects, design decisions are typically made by viewing 3D forms that can be rotated in real time. Although viewing in 3-D can be effective, it is both time consuming and in many instances requires significant expertise to recognize (in 3D) the key molecular determinants of the interaction. One purpose of the technology herein is to provide the same information that informs 3D manipulations but in a form that they can be quickly appreciated without ever leaving the paradigm of the 2D line drawing. In this way, 3D properties can still be used in the decision making process of what new molecules should be synthesized, a decision-making process that dominates the day-to-day experience of medicinal chemistry.

In the embodiments herein, although the principles can be applied to any molecular structure, or complex of structures (such as a binary ligand-protein complex), the optimal form is for the augmentations to be applied to a small organic molecule. Thus, the augmentations described herein could be applied to portions of a protein binding site, given suitable 2-D coordinates for the same. However, the principal aim of the augmentations herein is to augment the 2-D diagram of a small organic molecule ligand. Properties of a cognate protein can be projected on to the small organic molecule itself so that the augmentations can convey both aspects innate to the small organic molecule's structure as well as aspects of its interaction with other molecules. This approach has the effect of reducing clutter on the resulting augmented representation because it focuses attention on the small organic molecule/ligand and pieces thereof.

In other aspects, the technology provides functionality, such as software functions and subroutines that can be assembled by a user into a customized protocol for displaying desired molecular attributes in a preferred manner.

### 2D-Layout

The instant disclosure assumes the terminology and concepts of “chemical graph theory”, in which a molecular structure is described mathematically as a graph. A graph is a mathematical construct defined by a set of objects and the pairwise relationships between them: the graph is built from the pairwise distances between the objects, and is depicted as a layout of vertices (one for each object in the set) interconnected by edges between objects that are adjacent. Each object in the set occupies a node (or vertex); it shares edges with those other objects to which it is adjacent. In its adaptation to depiction and manipulation of chemical structures, each node in the graph corresponds to an atom, and each atom shares an edge with each other atom to which it is chemically bonded. In organic chemistry, the only bonds that are typically displayed as edges are covalent bonds (a sharing of at least one pair of electrons). It is also normally the case that, to reduce clutter, the hydrogen atoms are omitted, so that the chemical graph that is displayed just shows the “heavy”, or non-hydrogen atoms. Assuming formal valency rules for the elements commonly found in organic chemistry, a trained chemist knows from the chemical graph how many hydrogens are implied for each heavy atom that is depicted simply from the number of bonds that are shown.

Almost all 2D-layout forms utilized by chemists also have the following specific attributes, which together denote a canonical or “traditional” 2-D representation: all bond-lengths in the diagram are the same as one another; all bond angles are 120° except those within rings made up of other than 6 atoms; rings are shown as regular polygons (i.e., equilateral triangle, square, regular pentagon, etc.) regardless of heavy atom substituents and multiple or conjugated bonds within the ring; atoms are the vertices or termini of the graph; carbon atoms omit the letter “C” (so it is assumed that an unlabeled atom is a carbon atom); the chemical symbol for a heteroatom (“N”, “O”, “S”, etc.) replaces a vertex or terminus, i.e., is within the graph; bonds to hydrogen atoms and the hydrogen atoms themselves are not shown explicitly, except where needed to denote a particular stereochemistry, and except where attached to a heteroatom where the hydrogen atom(s) are conflated with the symbol for that heteroatom (e.g., “OH”, “NH₂”); double and triple bonds are shown as two and three parallel lines, respectively. Unit charges are shown with “+” and “−” symbols next to a formally charged atom, as applicable. Some limited stereochemistry at tetrahedral carbons can be indicated by use of “hash” and “wedge” bonds, and may include showing an explicit bond to a hydrogen atom where necessary to indicate a particular enantiomer, diastereomer, or other chiral center. Other bond forms, such as a wavy line, to denote an unknown stereochemistry, are also recognized in the art.

It is to be understood however, that where minor variants of the traditional 2D structure diagram are in use, the methods described herein for augmenting such a diagram can equally be applied.

The methods herein can be applied to an existing scheme or computer implementation for generating a 2D representation of a molecule or assemblage of molecules. Thus, such an existing scheme can be one available commercially, or one developed using layout principles known in the art.

In one embodiment, therefore, the methods herein are applied to, and augment, an existing 2-D representation and provide useful and informative augmented 2D representations according to one or more guiding rules. For example, the methods for augmentation described herein may receive, as input in some suitable file format, 2-D display coordinates for a molecular structure generated by some other source.

In another embodiment, the methods herein are embedded within a 2D layout generation program that utilizes a connection table or 3-D coordinates as input. In which case, a first step is to generate a set of 2-D coordinates in the traditional depiction before applying augmentations as described herein.

In either case, the augmented 2-D structure can include minor modifications such as addition of color to the line-drawing itself, even though in most instances the augmentations herein do not change in any respect the 2-D drawing. In some other embodiments the 2-D structure diagram is imported as a graphic object.

A given molecular structure, presented either as coordinates in 3-D for each atom, or as a connection table, can give rise to a number of different 2D layouts. Choosing a canonical form of layout is outside the scope of the instant disclosure, but methods are known in the art, and implementation thereof (if required) is within the skill of a programmer in this art. However, in general, in preferred embodiments, a user can choose, or a computer program executing the method will force, a molecule to adopt the most “extended” 2D layout where several 2D layouts are possible. In particular, where pendant groups may adopt alternative positions via ‘rotation’ around a rotatable bond, even though the primary consideration is to avoid clashes, a further consideration is to minimize the number of ‘inaccessible’ or buried atoms, and thereby cause the layout to show as extended a form of the molecule as possible. For example, one heuristic that may be applied to achieve this is to maximize the greatest 2D-distance between any pair of atoms in the structure when choosing which of several 2D layouts is possible.

### Guiding Rules

To attach additional information to an established representation such as a 2D line drawing of a chemical structure in a way that enhances the ease of perceiving that additional information, it is important to follow certain guiding rules. Embodiments of the technology as described herein can apply any two or more such guiding rules, in combination, but preferably three or more, in combination.

The primary guiding rule is to respect the original representation. In this case, the original representation is the familiar 2D molecular structure diagram, as described elsewhere herein, such as one in which all bond-lengths are the same as one another, carbon atoms are the vertices or termini where the chemical symbol “C” is not shown, bonds to hydrogen atoms and the hydrogen atoms themselves are not shown explicitly, except where attached to a heteroatom where they are conflated with the label for that heteroatom (e.g., “OH”, “NH₂”). Since the original representation is already known to be successful, then enhancements and augmentations should not simultaneously detract from it. Any attempt to ignore this guiding rule would result in a representation that is less effective than the original. For instance, altering a 2D representation by adjusting the line style for different bonds to represent bond order information would represent a change to the underlying representation that would not be particularly advantageous. Nor would it lead to great flexibility of augmentation. Therefore, in preferred embodiments, the original form of the 2D representation should remain untouched, other than that where a choice of such representations is possible, the preference would be to force the molecule to adopt an extended layout. The enhancements are added to, or superimposed on, the 2D representation, preferably without obscuring or obfuscating any part of it.

The second guiding rule is to not impose too much additional information; doing so is likely to produce clutter and thereby an impairment of the original 2-D scheme. This means that there are limits to how much information should be added to any 2-D structure. As will be clear from the description herein, there are many different properties, 3D or otherwise, that can be added. Adding a single additional property is straightforward; adding two requires thought, and adding three can require real expertise. The technology herein can successfully add as many as three different properties—and more—because of the forms of display that have been carefully made available for different categories of property.

The third guiding rule addresses the layering of several types of information on or in the same 2-D structure diagram. When it is desired to represent more than one form of information, it is preferable to choose visually different forms for that information. In other words, the representations deployed on to a 2-D drawing should be as ‘orthogonal’ to one another as possible. Put another way, different forms of information should not be represented in similar ways on the same diagram. The examples given herein further illustrate this guiding rule.

The fourth guiding rule is to choose a form that captures some of the character of the information itself, i.e., achieves a verisimilitude of representation. For example, in the case of the accessible line contour, the form is designed to capture information about what the depicted molecule interacts with, be it protein, solvent or void volume. As the concept of an accessible surface in 3D is well established, this 2D counterpart already has verisimilitude as a representation of the interface between a molecule and its exterior environment. Similarly, it makes sense to represent field properties (such as electrostatic potential) by shaded regions.

The fifth and final guiding rule is to use text sparingly. Sometimes text can be appropriate but it is not usually a dense (or compact) information source (graphical elements convey information more compactly) and, as such, quickly leads to clutter. The essence of good representation is just that: it conveys clearly what it wants to represent. This rule should not override common sense, i.e., sometimes there is the need to transmit precise information (e.g., a torsion angle or a strain energy) where text (in this case numerical values) is, in fact, the most appropriate, cleanest, most accurate form.

### Core Graphical Elements

The technology herein permits a user to add a set of different types of graphical elements to a 2-D chemical structure diagram. The types of graphical elements are chosen to be distinct from one another so that use of any two or more types within the same 2-D layout does not lead to conflicts, overlaps, or confusion.

There are five principal types of graphical elements provided by the technology, subsets or all of which, can be permuted amongst one another, at the choice, and discretion of the user. That aspect coupled with the fact that each type of graphical element itself embodies a number of different styles each of which has one or more features that can be controlled by one or several independent parameters, means that the number of possible ways of augmenting a 2-D chemical structure using the technology herein is both enormous and subject to great flexibility.

In particular, a given graphical element has associated with it a number of styles, that themselves are discrete and selectable in the sense of being chosen to apply by a user or not. But a particular style for a given graphical element, or the graphical element itself, additionally has a number of parameters that permit a user to define a value and thereby further control an aspect of the display. Some parameters, such as whether a particular graphical element has a line boundary or not, are themselves binary in nature. For each type of graphical element, style, and parameter as applicable, a preferred embodiment of the technology sets a default value or choice for each.

For each element, where there is an ability to choose a color or colors to define some aspect of the representation, colors can be selected by a user from a pre-defined list, such as from a palette, or can be selected from a continuous or near-continuous distribution as found in a color wheel or color map. Preferred colors can be saved and re-used within the same type of element, or for other types of element.

### Summary of Types of Graphical Element

Accessible line contour: This is useful for indicating properties in the vicinity of an atom on a ligand, especially properties from a cognate protein. The accessible line admits of a number of key distinctive variations, including at least: color, thickness of line, and style of pattern. Furthermore, multiple sources of information can be displayed simultaneously by embedding contours within each other to form an ‘onion’ shell.

Background color scheme: This is useful for indicating through-space properties impinging on the molecule, for instance the electrostatic potential generated by a cognate protein. Again, the background color scheme admits of parameterization, as further described herein. Suitable choice of coloring or shading patterns for the background color scheme permits it to be used with any of the other principal types of graphical element without visual conflict.

Discrete Set Representation: A discrete set of chosen atoms and/or bonds between them can be presented as a highlighted portion of the molecular structure. This is useful for indicating discrete sets of bonded atoms, e.g., being a part of a graph (substructure) that occurs in a second molecule. Further aspects of a selectable style for highlighting a discrete substructure include the color of the highlighting, and whether the highlighting itself has defined boundaries. It is also true that this type of highlight applied to bonds can co-exist with the other types of graphical elements in a given structure without conflict.

Atom Symbols: These provide a way to emphasize particular atoms according to properties and attributes. Specified atoms are overlaid with a circle (or other shape) drawn in a chosen style and color. The circles are drawn in such a way that they truly overlay, but do not obscure, the underlying 2-D structure diagram. The color choice, line style and thickness, as well as whether to shade the interior of the circle, provide a rich set of variables for this type of element.

Bond Symbols: These are useful for representing properties of bonds that are evident from the molecule's 3D structure or a calculation, but not from the 2-D drawing, such as ease of rotation, strain, or steric hindrance. These symbols are not easily confused with atom symbols, discrete set highlights, or any of the other graphical elements contemplated herein.

The first two graphical elements described hereinabove (the accessible line contour and the background color scheme) are the two principal elements provided by the technology, examples of which are given hereinbelow.

It should further be noted that an additional aspect of variation is provided by “layering” of the types of graphical elements in the augmented representation. The 2-D structure diagram can be considered to be in a “middle” layer. The various graphical elements can then be considered as being applied to one or more layers above the structure diagram, or to one or more layers below the structure diagram. An element applied above the structure diagram will often obscure those portions of the 2-D structure that are directly underneath it, unless its shading or coloring admits of a level of transparency or translucency that the underlying structure remains visible. In preferred embodiments, all graphical elements of a particular type reside in the same layer. For example, if several different sets of atoms are colored according to atom type graphical elements, those elements are all either above or below the 2-D ligand structure.

### Accessible Line Contour

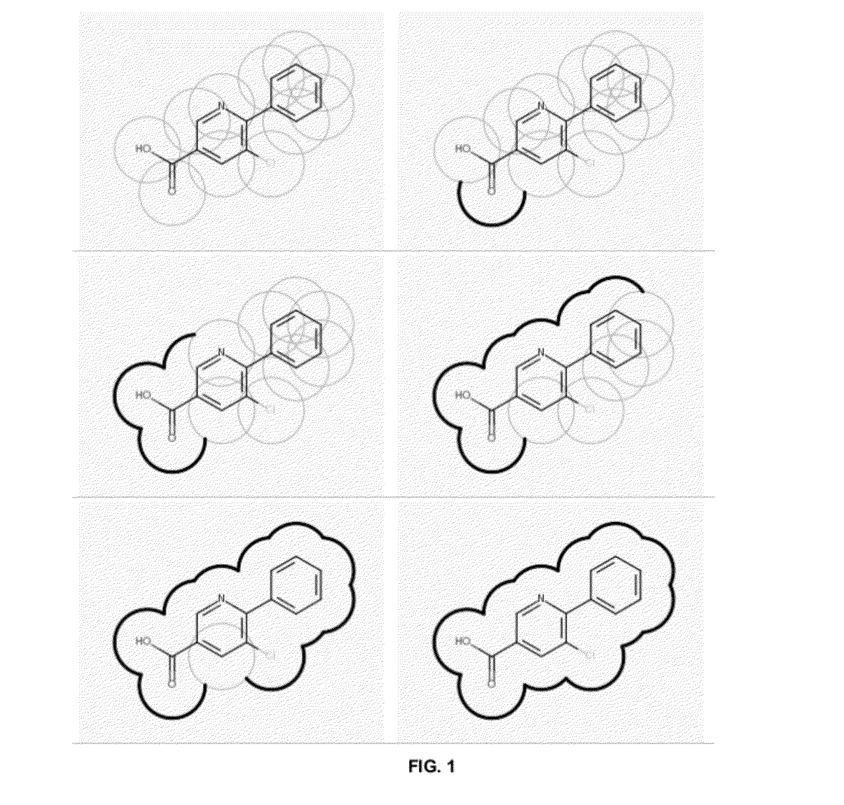

The accessible line contour around a molecule is formed by generating a circle centered on each atom in the 2D drawing and then identifying the external arc segments that define a continuous surface around the molecule. In practice, this can be achieved by removing all segments that lie within another circle. This process for an exemplary molecule is shown in FIG. 1. In the first panel, a circle is superimposed on each atom. In each successive panel of the figure, an external arc of a circle is converted to a bold line and the arcs of those circles that are interior to the ‘growing’ surface, are deleted.

In FIG. 1, and in a preferred embodiment, only a single radius is used for all of the circles, though variable radii (for example, set according to atom type, and set by a user) are consistent with the overall implementation. To aid the verisimilitude of the representation, the single radius used should approximate or be equal to the bond lengths in the 2-D drawing.

The surface need not only be depicted as a plain line, however. The accessible contour lines can be drawn in different styles, colored differently or not drawn at all (absence of lines can also carry information, or can be deployed simply to de-emphasize a portion of a structure that is not being analyzed in a particular view). Other simple variations include use of dotted or dashed lines (with suitable user choice of dot and dash size and frequency).

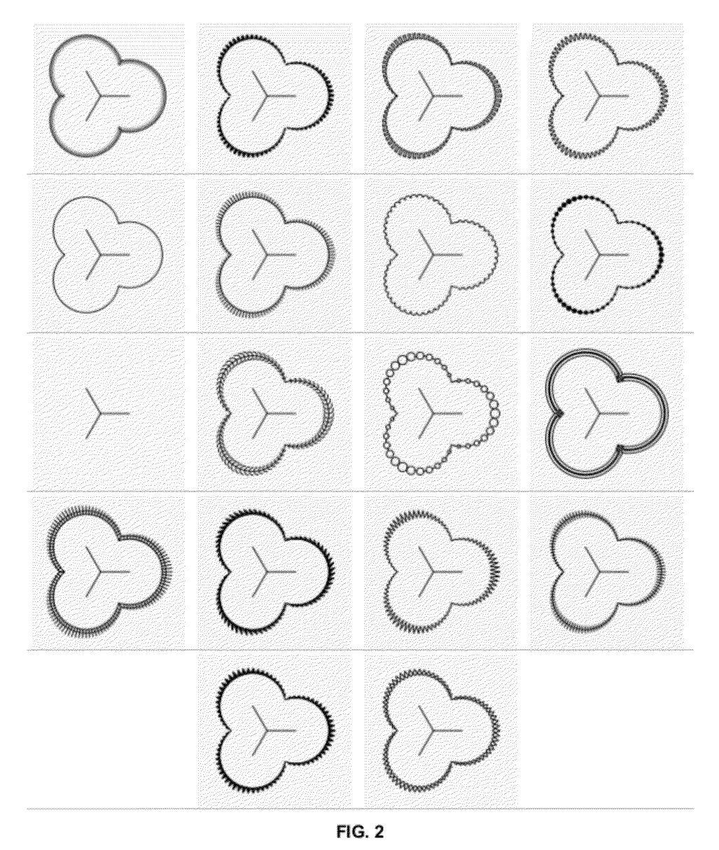

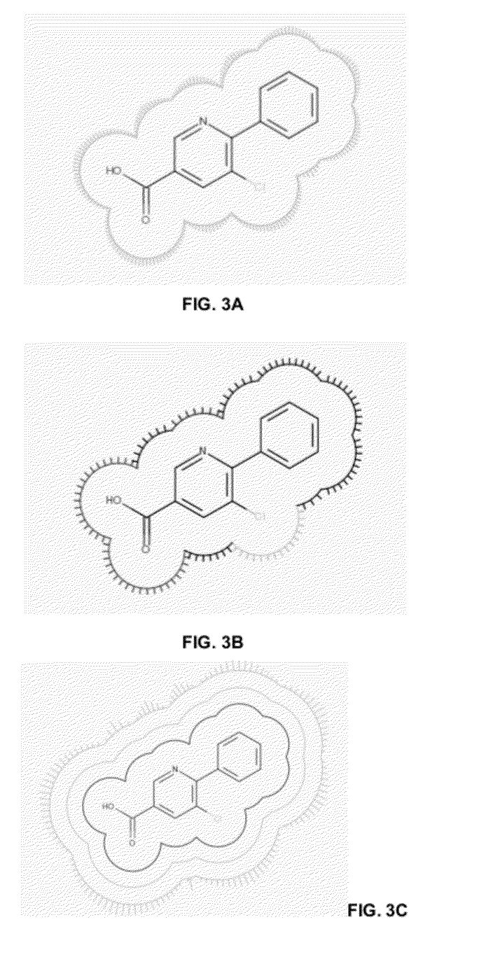

A number of different styles of line-surface can incorporate more complex patterns and be applied according to user choice, and circumstance. Exemplary surface line patterns are shown in FIG. 2, applied to a simple molecular structure such as isobutane. A molecule drawn with one such style is shown in FIG. 3A. This graphical element does not detract from the underlying 2D-structure, in which atoms are colored by type (chemical element) but otherwise the 2D layout is undisturbed.

Other properties can additionally be applied to the surface. For example, colors for specific atoms can be applied to the surface, as shown in FIG. 3B.

One disadvantage of the accessible line contour is that not all atoms have (2D) accessible surface area. These atoms are often buried in 3-D anyway, so the loss of a way to represent information about their contact with a surrounding protein may not be important.

An extension to the accessible line contour representation uses multiple line contours where successive contours are generated with slightly increased radii, and can be drawn in different styles. The use of multiple accessible line contours can be referred to as the ‘onion’ representation. An example is shown in FIG. 3C, in which different styles are shown on the successive contours, though it is not intended in this example to illustrate different properties on each successive surface. Although this form can present more information, it is also more cluttered and therefore should be used sparingly. Furthermore, as the radii increase, there is a risk of disenfranchisement of atoms that are slightly buried in the 2D representation.

### Background Color Scheme

Background color is a good way to add information for two reasons. First, traditional 2D structure diagrams normally use very little or no color in the first place—the background is typically white, and the line drawing utilizes black lines and black labels. As such, background color is automatically orthogonal to the underlying line drawing. Thus, the background color scheme is available in a number of different styles, at the choice of the user, which include but are not limited to, a palette of colors, and a selection of shading, and fill patterns, also having a parameterizable opacity.

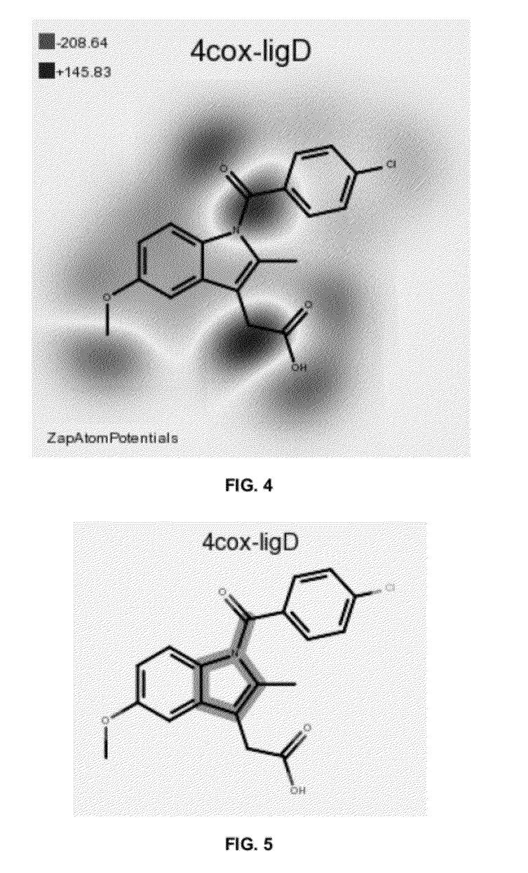

Second, any property that has ‘through-space’ character, for instance an electrostatic potential, can be thought of as having values at every point on the lines that make up the representation, as each line effectively represents a locus of points in 3D. This means that the physical through-space property should smoothly vary over the diagram in both 3D and 2D. A preferred way of depicting this in the technology herein is to use a Gaussian-weighted function that gives each point in 2D space a weighted average of nearby atoms. This value is then convoluted with a function based on a Gaussian dielectric function, such as produced by the program ZAP (OpenEye Scientific Software, Inc., Santa Fe, N. Mex.), that smoothly interpolates between inside and outside. The purpose here is to define a ‘locality’ to the property. For instance, the scaling factor to define where the background color titrates to background white should be chosen so that the color does not bleed over the accessible line contour. In this way, an optimal use of background coloring reduces clutter and enhances orthogonality. An example of a molecule having a background colored according to such a scheme is shown in FIG. 4, wherein red denotes negative potential, and blue denotes positive potential.

The technology herein is not dependent on choices of color, shading, or color scheme. Specific colors shown or referenced herein are exemplary. In preferred embodiments, a user will have a palette of colors, as well as a variety of stipplings, shadings, and fills (such as lines or cross-hatches) from which to choose.

### Discrete Sets

The Discrete Set representation can be used when the property to be displayed is not a continuous property but represents different classes, for example, the part of the structure that is in common with a second, reference, structure. This may resemble an overlay of tube-like elements on a network of bonds in the graph. FIG. 5 illustrates this representation: as shown, a discrete set of certain bonds (and their atoms) are highlighted.

The highlights can be varied in at least the following ways, at a user's discretion: thickness, color, boundary or no boundary, as well as having texture (such as stippling) and lighting (such as to mimic illumination from a light source).

A diagram can be annotated with several different discrete sets, although this becomes cluttered if the sets are not disjoint. Care also needs to be taken to avoid clashing with any simultaneously applied background color scheme. One way to minimize this issue is to have a line edge to the highlight that includes the atoms in the specified set, even though it is generally preferred to avoid any additional lines within the area occupied by the 2D chemical structure drawing.

Other parameters having user-defined values that can control the appearance of the highlighting include the width of the highlights, and a level of opacity (transparency) of the highlighting.

### Atom Symbols

Specified atoms can be highlighted according to chemical atom type (carbon, nitrogen, etc.), as well as bonding environment (hybridization, sp², sp³, etc.). A typical example of this graphical element is a circle superimposed on the atom or atoms in question. The two principal variables to indicate a particular property are the color of the circle, and the circle style. Each can be used independently, in conjunction with the other, or not at all. The circle style can be based on the same sets of styles as used in depicting the arcs on an accessible surface (described elsewhere herein) and typically involves a defined pattern repeating itself around the circumference. The color can be applied to the lines from which the circles are drawn as well as, and independently of, the shading in the interior of the circles.

As described further in the examples herein, most styles for drawing atom circles also admit of some user-controlled variation in the proportions of the geometric features in the pattern.

### Bond Symbols

There are several bond properties that relate to 3D properties that can be symbolically represented on a 2D diagram. This type of element comprises a symbol that is superimposed on the bond, or within a bond angle. It is important for the symbols chosen to be distinctive. The following symbols can preferably be used: arrows, squares, and circles or ellipses, though others not specifically described herein are within the scope of the technology.

Again, specific parameterizations of the bond symbols give rise to a huge variety of possible representations. For example, double-headed arrows can have variable length, line thickness, and arrrowhead-style. Squares can be chosen according to color size, and boundary line.

One important property is the local strain energy. If a molecule binds in a strained configuration, it is natural to want to consider changing the chemistry to relieve this negative contribution to binding. Strain typically occurs in torsions, less so in angle bends and less again in bond stretches. Such quantities can be calculated from quantum mechanics or from force fields. When a strain exceeds either statistical norms or preset limits, depictions can alert the viewer to this fact without detracting from the 2D line drawing. The degree of strain can be indicated by, for example, line thickness, color or size of the symbol.

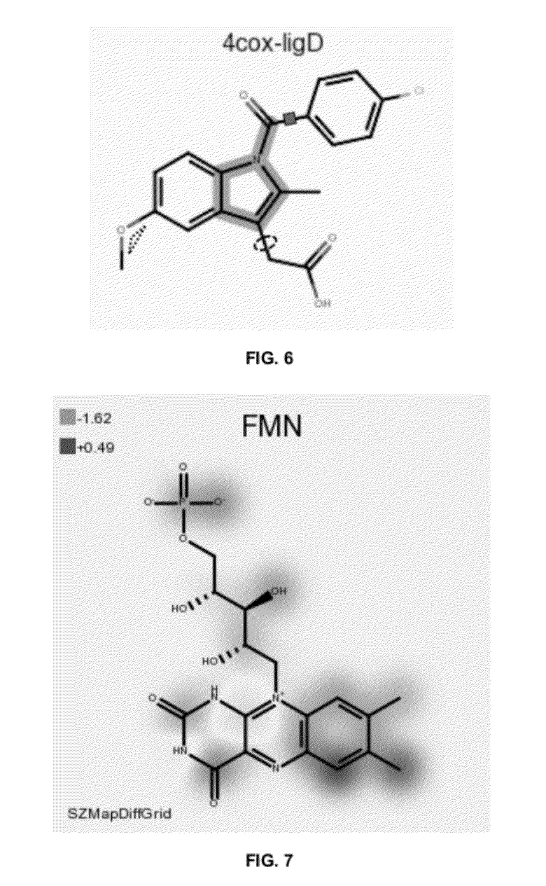

In FIG. 6, the view from FIG. 5 is augmented by indicating a number of different styles of bond symbol. A strained torsion is represented by an ellipse aligned perpendicular to the bond; a strained angle is shown as a triangle wedged into the site of strain; and a restricted torsion is shown as a red square. A restricted torsion is not necessarily a strained torsion; rather it is a torsion that has high barriers to conversion between torsional minima. If this barrier is high enough, a molecule can remain torsionally trapped in a conformation for time scales important to the pharmaceutical industry.

Individual parameterization of the various bond symbol styles include: color; shading; the aspect ratio (major/minor axis ratio) of the ellipse; size of the square and triangle; presence or absence of a line boundary on a square or triangle.

### Exemplary Applications

Any two or more of the five types of graphical element described hereinabove can be combined seamlessly when augmenting a 2D molecular structure diagram because they have good display orthogonality. They can further be combined with textual information, typically located near atom centers if pertaining to the 2D molecule, or outside the accessible line contour if pertaining to a cognate protein, to provide a highly enriched information source.

The following are some examples of applications and methods that can use the technology herein to inform a user of key atomic and/or molecular properties at play in a given chemical structure analysis.

Exemplary applications 1-4 apply to the use and form of an accessible line contour. Exemplary applications 5 and 6 can combine background coloring with an accessible surface. Exemplary applications 7-11 apply to the use of background shading or coloring. Exemplary applications 12 and 13 use the discrete set, or highlighting, form of graphical element. Such a variety of applications is possible because the user has aspect to a number of underlying functions and tools for augmenting a 2-D representation.

### 1) Contact Nature Between a Ligand and a Protein

There are understood to be three principal forms of contact between a small molecule and a protein: void, solvent, and trapped solvent. Void contact means that the space between an atom of the ligand and atoms on the protein does not contain solvent, water; i.e., water has been excluded between the ligand and the protein. This is the most common form for a well-fitting ligand, i.e., the protein moulds itself around the ligand, squeezing out solvent. The second form is solvent, i.e., if the molecule is not completely enclosed by the protein, some atoms will still contact solvent exterior to the binding site. Finally, a third case is rarer but happens frequently enough that it has been studied separately. Here, the molecule traps water between it and the protein, meaning that these water molecules can no longer exchange with bulk solvent without clashing with the protein or the ligand: the complex contains a solvent bubble.

Any particular atom can have one, two, or all three types of contact but an approximation can be made to what its majority contact might be. This can then be represented by the accessible line contour. Thus the accessible surface contour can be divided into segments that have a different representation (style) according to whether the local majority contact is void, solvent, or trapped solvent. For example, a solid line can indicate void contact. The width of this line can be used to represent whether the void is wide or narrow. A dashed line can represent the solvent contacts, or indeed by no line at all since this then has greater verisimilitude. Finally, a dotted line can represent the contact to trapped solvent. Other forms of accessible surface that can be used to denote these types of interaction are shown in the Examples.

### 2) Character of Contact

The technology herein can be used to display the character of the various contacts between a ligand and a protein, for instance whether a particular contact is polar, hydrophobic, hydrogen-bonded, or ionic. It is straightforward to calculate these quantities for a given atom, using various methods and techniques known in the art. Therefore it is possible to alter a given portion of the accessible line contour to represent the nature of a particular contact. Thus a separate style can be established for each type of contact, and applied accordingly to the applicable portions of the accessible surface line.

Again, a single atom may actually have multiple such contacts. It may be possible to represent this by, e.g., partial coloring of the contact contours. Alternatively a majority decision may need to be made, e.g., most of the protein contacts to a particular atom are hydrophobic.

### 3) Vicinity

Often a chemist will want to know the consequences of extending a molecule in the direction of a certain group. There are at least four natures to such extensions: clash, solvent, displace trapped solvent, and pocket. The first of these, clash, simply indicates that extending a molecule in this direction seems unwise, as it would lead to a clash with the protein. The second shows that the group can be extended because it is just moving into solvent. The third indicates that an extension is possible because at the moment the space is occupied by trapped water that can be displaced. Finally, a ‘pocket’ shows that there is room to extend the molecule, displacing free, not trapped solvent, and that there is potential for increased shape complementarity. The last three cases all are potentially interesting for a chemist, for different reasons. Extending into solvent might be useful for potency, via the effect described hereinabove. Displacing a trapped water might be energetically favorable or not, depending on the activity of the water. Finally, extending into a pocket will make new interactions, which can be estimated. The nature of the extension can be represented by the accessible line contour and the energetic consequences assigned to each atom and represented by a background color scheme. Calculating the equivalent properties from extending by successive carbons can extend this concept of vicinity, i.e., what happens if the group is extended by one, two, or three carbon atoms.

Each of these four categories is ripe for display in an augmented 2D representation as described herein. The visualization is particularly potent when applied to a group of molecules: a particular group can be color-coded according to which of the four types of extension is predicted.

### 4) Conservation of Pockets

Specificity of interaction is a concern for all of drug discovery. One simple metric that is used is whether the areas of contact are similar in related proteins. This can be illustrated easily with the accessible line contour. It could also be illustrated via an ‘onion’ representation on a single structure diagram: for example each contour for a given molecule could represent the interaction with a different (but related) protein.

### 5) Electrostatic Potential

Knowing the potential from a cognate protein is useful for estimating electrostatic complementarity: are polar groups of the right electronegativity positioned in regions of opposite potential? Although reliance on electrostatics alone can be misleading as electrostatic complementarity is only a necessary, but not a sufficient, component of a successful recognition event, account also needs to be taken of the effect of desolvation of the protein and the ligand (see also hereinbelow). However, there are cases where a direct estimate of binding can be relatively accurately assessed from electrostatics, and that is for atoms that are not desolvated on binding. These atoms are those for which the nature of the protein contact is ‘solvent’. Thus by combining an accessible line contour that shows the “nature of contact” with an “electrostatic potential” background color scheme, it would be straightforward for a chemist to quickly see atoms where a change to a more or less electronegative group might increase ligand affinity. An effect of this level of subtlety rarely leaps to the fore in a conventional molecular modeling environment that is centered on 3D display.

There are many methods known in the art for calculating atom-based charges, varying from very simple empirical models to those that derive information from a quantum mechanically calculated wavefunction. Atom charges derived from any of these methods can also be used in deriving an electrostatic potential that can be displayed as a background color scheme in 2D using the methods described herein.

### 6) Atom by Atom Interaction Potentials

In various energy partitioning schemes, it can be possible to map the energy of interaction between a ligand and protein to each atom of the ligand, thereby identifying hot-spots of interaction. For example, energy can be assigned to each ligand atom that represents its contribution to electrostatic binding. This energy differential can then be displayed using a background color scheme to the molecule, or as a coloring of the accessible surface.

### 7) The Activity of Displaced Water

When a ligand binds to a protein and displaces water, that water has a specific ‘activity’ due to its previous interaction with the protein. Water involved with a highly polar group has a higher activity than one in a hydrophobic region. This activity can be estimated with simulation or semi-continuum theory. It represents an indicator as to whether the effect of displacement is more or less favorable compared to the expected theory of water of uniform activity (mean-field or continuum theory). The computer program SZMAP, available from OpenEye Scientific Software, Inc., New Mexico, USA, estimates this quantity and it is a guide to the expected nature of atoms in a ligand efficiently bound to a protein. FIG. 7 illustrates this for Flavoid-MonoNucleotide (FMN) bound to FMN-binding protein. As can be seen, the SZMAP map displayed as a background color scheme correctly predicts the dominant polar parts and non-polar parts of the molecule. This can be used as a ‘visual’ scoring function, as a way to suggest isosteric replacement (less polar, more polar groups of similar size.

### 8) Docking Scores

One important use of a background color scheme is to represent general interaction energies, such as found in scoring functions for molecular docking. A particularly simple, but useful, such function is the shape match function that describes the number of favorable close contacts of a ligand with a protein. This shape function, as implemented in computer program FRED, available from OpenEye Scientific Software, Inc., New Mexico, USA, is a through-space property, and so is appropriate for the background color scheme. A chemist can then assess, without needing to use a 3D graphics environment, where the ligand is fitting well and where it fits poorly.

### 9) Illustrating Clashes

Sometimes ligand structures appear to clash with a protein in which they are being docked. As clashes typically involve very unfavorable contributions to binding, these clashes are often artifactual, e.g., a consequence of an incomplete minimization or poor docking or posing. The accessible line contour represents a simple manner to display clashes, either by width of line or color. Combined with a shape complementarity function and represented as a background color scheme, the chemist then sees both continuous and discrete information about the shape fit of a molecule.

For example, “shape complementarity” can mean a complementarity function calculated using ShapeTK, available from OpenEye Scientific Software, Inc., Santa Fe, N. Mex. The Shape TK can calculate the overlap between two molecules in 3D. It does this by representing each molecule as a continuous field and then measuring the overlap between these fields. For 3D similarity, the higher the shape overlap of two ligands, the more similar the two ligands are. But the same algorithm can be used to measure the clash between a ligand and a protein. In this application, the higher the overlap, the more there is a clash. This shape function can be decomposed to a per-atom field property so that clashes can be depicted as a background field on the ligand depiction.

### 10) Electrostatic Optimization

It is possible to estimate a set of ligand charges that will optimize the interaction between a protein and ligand. This set of ‘perfect’ charges is often not physical, but can provide an indicator of which sets of atoms ought to be more electronegative and which less. This can be represented as a through-space property, and hence as a background color.

### 11) Electron Density Fitting

One of the important uses of the shape overlap concept is in fitting ligands to electron density. However, information as to the quality of fit and of the strain induced upon fitting, are usually lost to both chemist and modeler. This can lead to over-interpretation of the quality of the fit. The technology herein provides simple measures to correct this failure to communicate from crystallographer to chemist or modeler. The overlap from the molecule to the density can be represented as a though-space property, plus strain can be illustrated with the bond symbols discussed above. This information can then be carried forth into representations of protein-ligand interactions, e.g., so that a modeler or chemist can judge the likely accuracy of an assessment from a protein-ligand interaction. In this approach, overlap would be between one structure and electron density of another structure, used as a ‘reference shape’. There would be no need to show, additionally, a reference 2D surface.

### 12) Protein Localization

A useful shorthand for areas of protein-ligand interaction is the concept of a ‘pocket’. Such pockets usually go by the name of S1, S2 etc. As each atom in a ligand can be associated with a given pocket in the protein binding site, this can be represented by the discrete set representation where each pocket is given a defined color, applied to highlight the group of ligand atoms that reside in that pocket.

It is also possible to alert a chemist to the presence of an unoccupied pocket nearby to a group. Here, the distance to the nearest unoccupied pocket forms a through space property. Alternatively, unoccupied pockets can be labeled, and such labels transferred to atoms within reach and displayed using the discrete representation and judicious highlighting.

### 13) Ligand-Ligand Correspondence

As well as using the technology herein to convey information concerning protein-ligand interactions it can also be use to evaluate the correspondence between two molecules in 2D or their superposition in 3D.

A first situation is where graph patterns match between molecules, a typical method of assessing similarity. This is an example for use of the discrete set (highlight) representation.

Second, when molecules are superimposed it is often difficult to disentangle the overlap in 3D. The technology herein provides simple methods for comparison, for instance via the through-space property of volume overlap or feature mapping, or via the line contour method (atoms that do not match are likely to be on the periphery of a molecule). This can also be applied in conjunction with the other representations when multiple ligands are aligned in an active site: for example, how much overlap is there between a given ligand and another ligand or set of ligands.

### Computing Apparatus

Various implementations of the technology herein can be contemplated, on computing apparatuses of varying complexity, including, without limitation, workstations, PC's, laptops, notebooks, tablets, and other mobile computing devices, including cell-phones, mobile phones, and personal digital assistants. The computing devices can have suitably configured processors, including, without limitation, graphics processors, for running software that carries out the methods herein.

Control of the computing apparatus can be via a mouse, keyboard, track-pad, track-ball, touch-screen, stylus, speech-recognition, or other input such as based on a user's eye-movement, or any subcombination or combination of inputs thereof.

The manner of operation of the technology, when reduced to an embodiment as one or more software modules, functions, or subroutines, can be in a batch-mode—as on a stored database of molecular structures, or by interaction with a user who inputs specific instructions.

The 2D representations created by the technology herein can be displayed in tangible form, such as on one or more computer displays, such as a monitor, laptop display, or the screen of a tablet or cellular phone. The 2D representations can further be printed to paper form, stored as electronic files in a format for transferring or sharing between computers, or projected onto a screen of an auditorium such as during a presentation.

In still further embodiments of the technology, a user can interact with the 2D representation via a touch-screen, to select parts of the representation, change display options, grab and move portions of a displayed molecular structure, or perform other similar operations.

ToolKit: The technology herein is preferably implemented in a manner that gives a user access to, and control over, basic functions that provide key elements of display, including but not limited to, the types of graphical elements described herein as well as others that are consistent with principles of representation and display as set forth herein. Certain default settings can be built in to a computer-implementation, but the user is preferably given as much choice as possible over the augmented representations of 2-D structures.

The toolkit can be operated via scripting tools, as well as or instead of a graphical user interface that offers touch-screen selection, and/or menu pull-downs, as applicable to the sophistication of the user. The manner of access to the underlying tools by the user is not in any way a limitation on the technology's novelty, inventiveness, or utility.

The computer functions for achieving an augmented representation of a 2D chemical structure diagram can be developed by a programmer of skill in the art. The functions can be implemented in a number and variety of programming languages, including, in some cases mixed implementations. For example, the functions as well as scripting functions can be programmed in C++, Java, Python, Perl, .Net languages such as C#, and other equivalent languages. The capability of the technology is not limited by or dependent on the underlying programming language used for implementation or control of access to the basic functions.

The technology herein can be developed to run with any of the well-known computer operating systems in use today, as well as others, not listed herein. Those operating systems include, but are not limited to: Windows (including variants such as Windows XP, Windows95, Windows2000, Windows Vista, Windows 7, and Windows 8, available from Microsoft Corporation); Apple iOS (including variants such as iOS3, iOS4, and iOS5, and intervening updates to the same); Apple Mac operating systems such as OS9, OS 10.x (including variants known as “Leopard”, “Snow Leopard”, and “Lion”; the UNIX operating system (e.g., Berkeley Standard version); and the Linux operating system (e.g., available from Red Hat Computing).

To the extent that a given implementation relies on other software components, already implemented, such as functions for displaying line segments, controlling fonts of textual symbols, etc., those functions can be assumed to be accessible to a programmer of skill in the art.

Furthermore, it is to be understood that the executable instructions that cause a suitably-programmed computer to execute methods for augmenting a 2D chemical structure diagram, as described herein, can be stored and delivered in any suitable computer-readable format. This can include, but is not limited to, a portable readable drive, such as a large capacity “hard-drive”, or a “pen-drive”, such as connects to a computer's USB port, and an internal drive to a computer, and a CD-Rom or an optical disk. It is further to be understood that while the executable instructions can be stored on a portable computer-readable medium and delivered in such tangible form to a purchaser or user, the executable instructions can be downloaded from a remote location to the user's computer, such as via an Internet connection which itself may rely in part on a wireless technology such as WiFi. Such an aspect of the technology does not imply that the executable instructions take the form of a signal or other non-tangible embodiment.

### Conclusions

The technology herein provides elegant and novel ways to project molecular structure information that is normally the province of 3D graphical display onto a familiar representational paradigm, the 2D molecular structure diagram. The augmented 2-D representations created thereby can then be used to guide the process of molecular design, whether with protein structural information or with structure activity relationships amongst related ligands.

The following examples illustrate various uses of the technology herein, as well as various aspects of exemplary implementation. The form and content of the Examples herein is not to be taken as limiting in any way on the scope of the technology or the appended claims.

### EXAMPLES

### Example 1

### GraphemeTK

Examples of many of the methods and embodiments described herein have been implemented at OpenEye Scientific Software, Inc., New Mexico, USA, in a computer program referred to as GraphemeTK.

The GraphemeTK provides several representation schemes that allow visualization of complex molecular interactions and properties in a clear and coherent 2D format that is the most natural to chemists.

GraphemeTK comprises a tool-kit that offers a skilled user access to a number of discrete functions, each of which can control a graphical element, style thereof, and/or provide a user with options to select a style pertinent to a particular element, and parameters for controlling that style.

The tool-kit offers the user an ability to work with other chemical structure viewing and calculation tools so that the results of particular types of calculation can be displayed in a customized manner.

It is to be understood that, although GraphemeTK provides a large number of types of graphical element, and associated styles and parameters with which to augment a 2-D structure, the technology herein is not limited in scope to those elements, styles, and parameters, that are provided by GraphemeTK.

### Example 2

### Atom Annotations

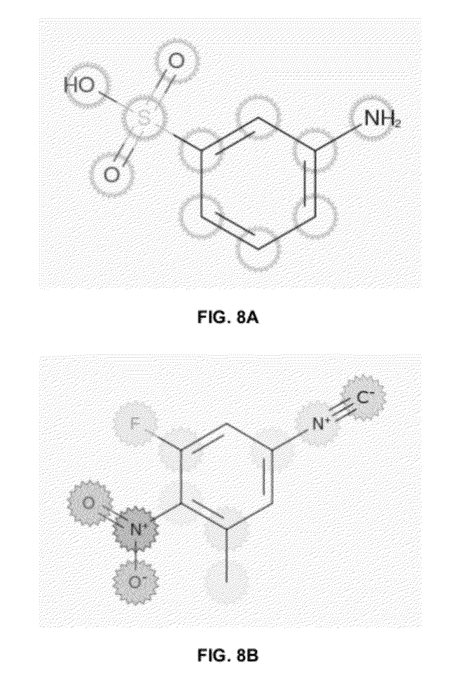

FIG. 8A shows a 2-D chemical structure drawing augmented with atom symbols applied to atoms according to their hybridizations. In this example, atoms that are sp3-hybridized are shown overlain with pink circles that have an ‘eye-lash’ style, further described herein. The sp2-hybridized atoms are shown overlain with light blue circles that have the “flower” style, further described herein. The heteroatom labels and the bond-segments they share in the underlying 2-D structure drawing are also colored: oxygen is red; sulfur is yellow; and nitrogen is dark blue.

FIG. 8B shows a 2-D drawing augmented with atoms represented by their point charges. Specifically, atomic point charges have been calculated (for example from a molecular mechanics force field) and then the color interpolated by a color gradient from blue (positive) to red (negative). A circle is superimposed on each atom, colored according to the charge-to-color mapping, and shown with an exemplary line style (“sun”) for the circle boundary.

### Example 3

### Bond Annotations

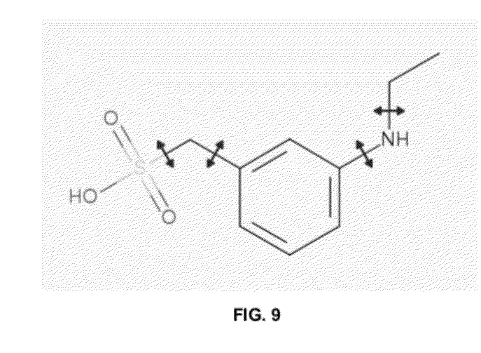

FIG. 9 shows a traditional 2-D molecular structure with certain bonds annotated according to whether it is rotatable. A double-headed arrow is superimposed on each rotatable bond. The arrow can be colored, and the size and style of the arrow-head can be customized according to a user's preference. In this example, the different heteroatoms are also color-coded in the 2-D diagram itself.

### Example 4

### Molecular Surfaces; Two Different Properties on One Drawing

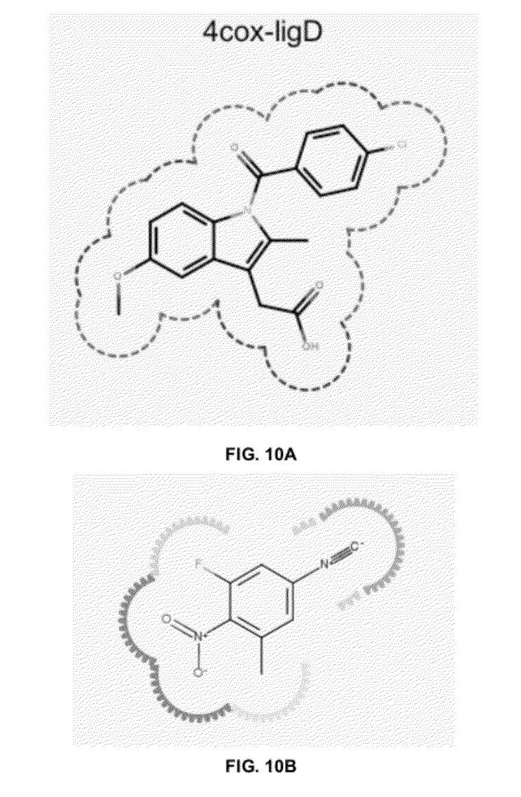

FIG. 10A shows the use of a property-based color scheme for individual atoms, and an accessible line contour, on the same 2-D representation.

FIG. 10B shows an example of depicting atom properties on a molecular surface. In this example, partial charges for the surface atoms, mapped on to a red-blue color gradient as in Example 3, are shown as the color of the surface arc segments corresponding to each atom. The surface arcs are shown in the “brick road” style as further described herein. The underlying 2-D structure diagram is undisturbed by this overlay.

### Example 5

### Ligand-Protein Complexes

In this example, the arcs of the 2D surface of the molecule are annotated, based on the distance between the accessible surfaces of the ligand and the surrounding protein. Based on this calculation, the atoms of the ligand are divided into four categories which are then inherited by the corresponding arcs when the 2D molecule surface of the ligand is drawn. These four types are the following:

Solvent: A surface arc is depicted using the solvent style if the corresponding atom is accessible to a solvent. One way of depicting this style is shown in FIG. 11, panel A.

Cavity: A surface arc is depicted using the cavity style if in the region of the corresponding atom, a cavity is detected between the ligand and the receptor molecule surfaces. The cavity is large enough to allow expanding the ligand in this region without bumping into the receptor. One way of depicting this style is shown in FIG. 11, panel B.

Void: A surface arc is depicted using the void style, if in the region of the corresponding atom a small interstice is detected between the ligand and the receptor molecule surfaces. One way of depicting this style is shown in FIG. 11, panel C.

Buried: A surface arc is depicted using the buried style, if in the region of the corresponding atom the ligand is tightly fit to the receptor. One way of depicting this style is shown in FIG. 11, panel D.

It is to be understood that the four styles shown in FIG. 11 are representative. Other arc styles (as further described herein) can be chosen for any of the four surface types.

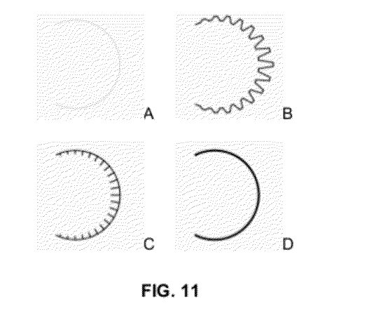

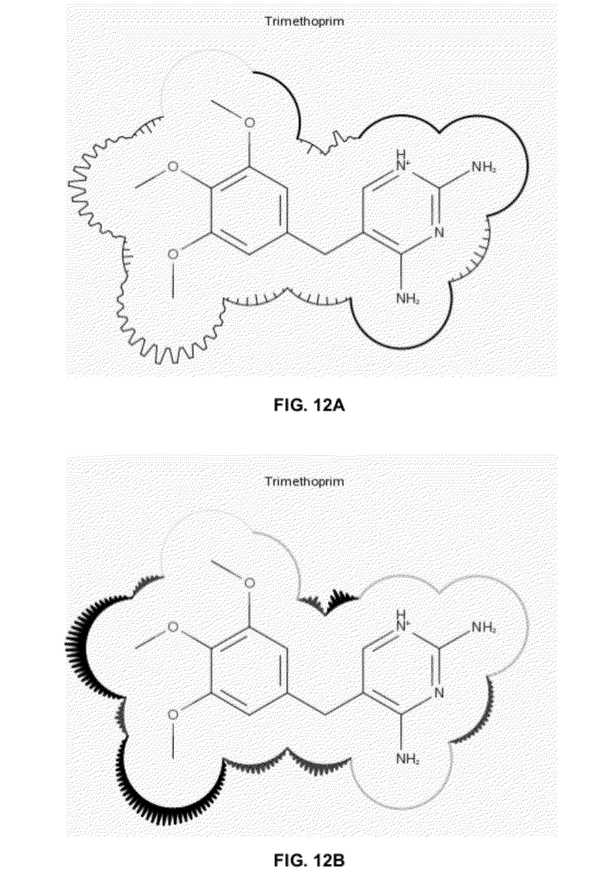

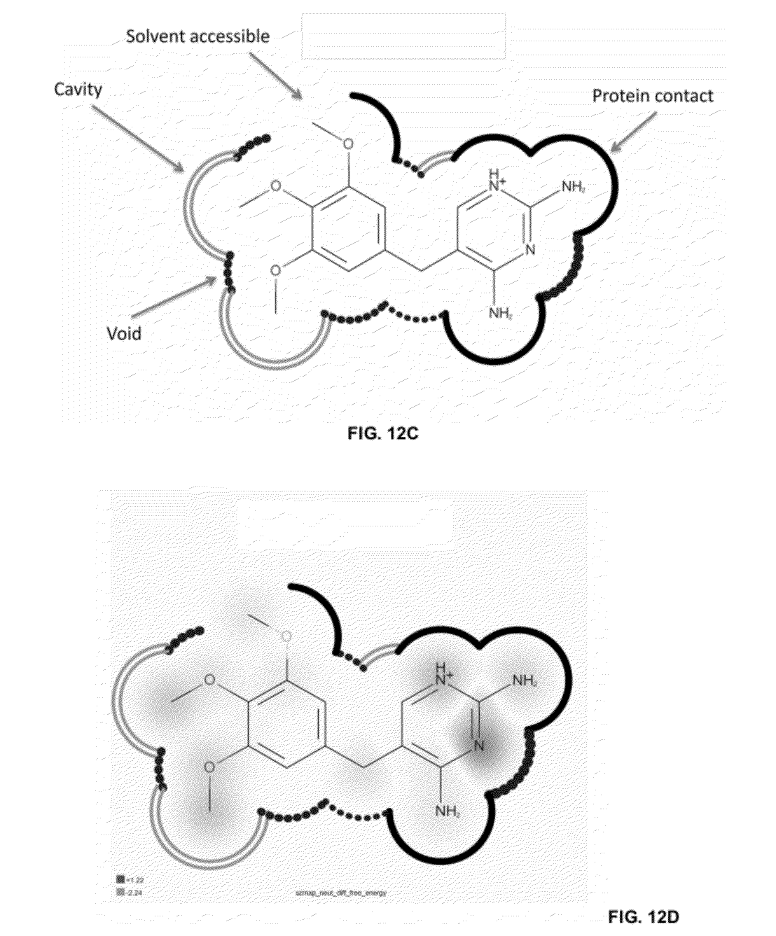

An example of a molecule within a receptor whose surface is depicted according to these categories is shown in FIGS. 12A-12D. This is trimephoprim in the protein 2w3a. The underlying 2-D structure diagram is unaffected by the features shown on the molecule surface, each of which instructive connotes aspects of the molecule's interaction with the receptor, without explicitly showing any of the receptor atoms or receptor structure.

FIG. 12B shows the surface from FIG. 12A, augmented to illustrate the relative distance calculated between the ligand and the receptor at each point on the ligand surface. This distance is used to emphasize the volume of the cavity in which the molecule sits by adjusting the size of the spikes when drawing the surface arcs.

FIGS. 12C and 12D illustrate alternative styles for the various surface arcs; FIG. 12D additionally includes property field in the background. The annotations in FIG. 12C are to assist visualization herein only and are not required by the augmented representation.

### Example 6

### Depicting Atom Property Maps

In this example, atomic properties are projected into a 2D grid, also referred to as a property map. The projection can use a Gaussian weighting function centered on each atom. The effective “radius” (width at half-maximum intensity) of the Gaussian function can also be set by the user, for example by inputting a scaling factor. A default implementation uses half the bond-length in the underlying 2-D diagram as the “radius”.

Colors are rendered in each cell in the grid using a gradient mapping function that interpolates colors between a specified range. The choice of colors to represent the extremes of negative and positive charge is up to the user, though a default implementation uses blue for positive charges, and red for negative charges.

Once an atomic charge such as a partial charge has been calculated for each atom in the 2D structure diagram, (such as from a molecular mechanics force field), the property map can be constructed based on three colors.

A first color is the background color of the property map. A second color represents negative values (in this case charges). A third color represents positive values in the property map.

Exemplary colors are as follows: black, blue, blue tint, brown, cyan, dark blue, dark brown, dark cyan, dark green, dark grey, dark magenta, dark orange, dark purple, dark red, dark rose, dark salmon, dark yellow, gold, green, green-blue, green tint, grey, hot pink, light blue, light brown, light green, light grey, light orange, light purple, light salmon, lime-green, magenta, medium blue, medium brown, medium green, medium orange, medium purple, medium salmon, medium yellow, olive brown, olive green, olive grey, orange, pink, pink tint, purple, red, red-orange, royal blue, sea green, sky-blue, violet, white, yellow, and yellow tint. Other colors are of course consistent with the methodology herein.

The color gradient is initialized by searching for the minimum and maximum values of the charges for the molecule in question.

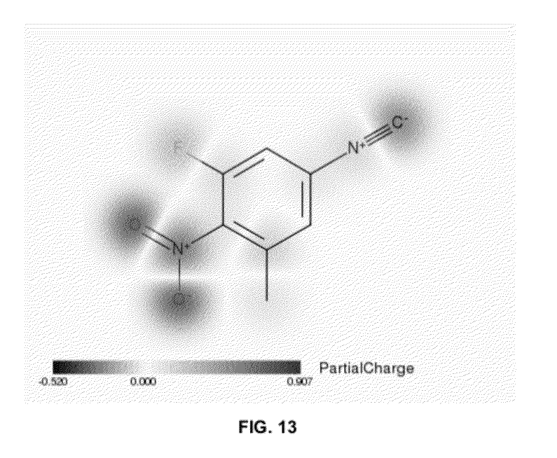

In this example, it is preferable that the property map, when depicted, underlays (rather than overlays) the molecular structure diagram, as in FIG. 13.

A legend is optional, and can be positioned at bottom, top, left, or right of the molecule, and oriented horizontally or vertically, as desired.

The display can also be configured to show more than one molecule, and the property map for each molecule can be established based on the minimum and maximum values of the charges for each molecule FIG. 14A, or for the ensemble FIG. 14B. The side bar to each molecule in FIG. 14B contains a box that shows the range of charges exhibited by that molecule within the entire range for the set.

### Example 7

### Atom Annotations

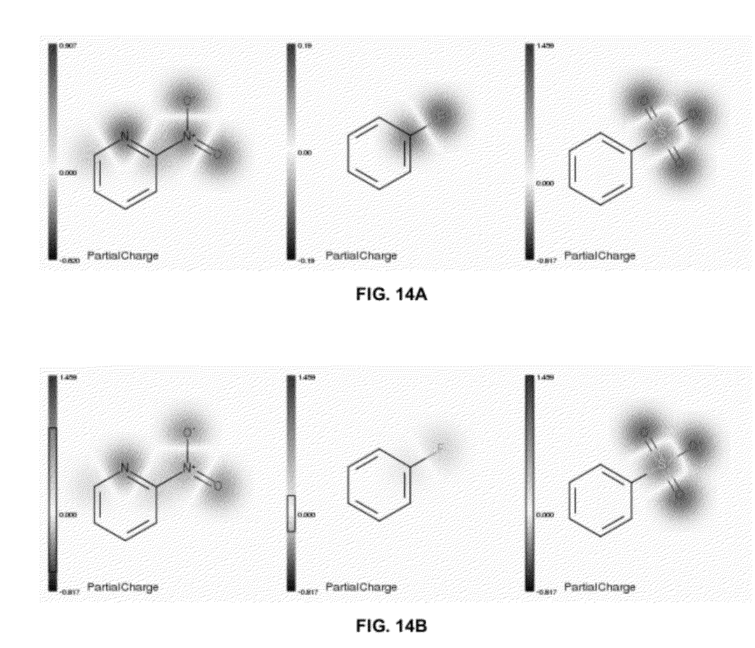

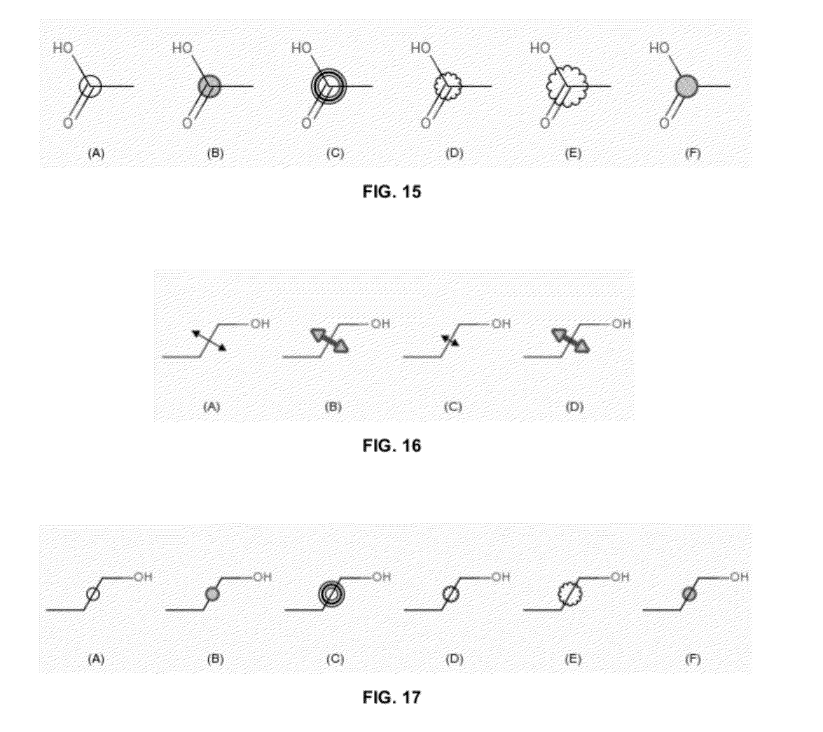

A number of parameters control atom annotations. FIG. 15 illustrates this for various styles, as applied to the carboxy-carbon atom in ethanoic acid.

In panels A and B of FIG. 15, choices of circle line thickness, color, and whether filled or empty, are shown for a plain circle style.

In panels C and D of FIG. 15, two exemplary circle drawing styles are shown.

Panels D and E of FIG. 15 illustrate a scaling factor that can be applied to a circle of a given style.

Panels B and F of FIG. 15 show contrasting options of whether to draw the circle above (i.e., overlying) or below (i.e., underlying) the 2-D structure diagram.

### Example 8

### Bond Annotations

A number of parameters control bond annotations of various types. FIG. 16 illustrates this for various arrow styles. FIG. 17 illustrates it for circle annotations.

Panels A and B of FIG. 17 illustrate different pen types that can be used to draw an arrow across a bond.

Panels A and C show different scale factors that can be applied to alter the displayed length of an arrow of a given style.

Panels B and D show that an arrow bond can be drawn above or below the bond in the 2-D diagram.

In panels A and B of FIG. 17, choices of circle line thickness, color, and whether filled or empty, are shown for a plain circle style.

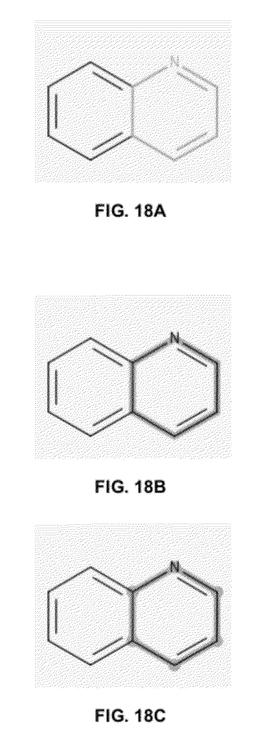

In panels C and D of FIG. 18, two exemplary circle drawing styles are shown.

Panels D and E of FIG. 17 illustrate a scaling factor that can be applied to a circle of a given style.

Panels B and F of FIG. 17 show contrasting options of whether to draw the circle above (i.e., overlying) or below (i.e., underlying) the 2-D structure diagram.

Although circle symbols for bonds could be used on the same structure diagram as circle symbols for atoms, this would violate the underlying guiding rules for representation, and therefore would not be preferred.

### Example 9

### Exemplary Highlight Styles for a Discrete Set of Atoms and Bonds

FIG. 18 illustrates a number of highlight styles for a naphthalene, in which a single benzene ring (on the right hand side of the molecule) is highlighted, as follows. In panel A, the benzene ring is colored blue, and thus contrasts with the remainder of the molecule diagram, which remains black. In panel B, the same substructure is highlighted blue and one bond between each pair of adjacent atoms in the ring is depicted in bold, for emphasis. This style is also referred to as a ‘stick’ style. In panel C, the benzene ring is highlighted blue, emphasized in bold, and each atom in the ring is highlighted with a spot. This style is also referred to as ‘stick and ball’ style.

### Example 10

### Comparing an Ensemble of Molecules

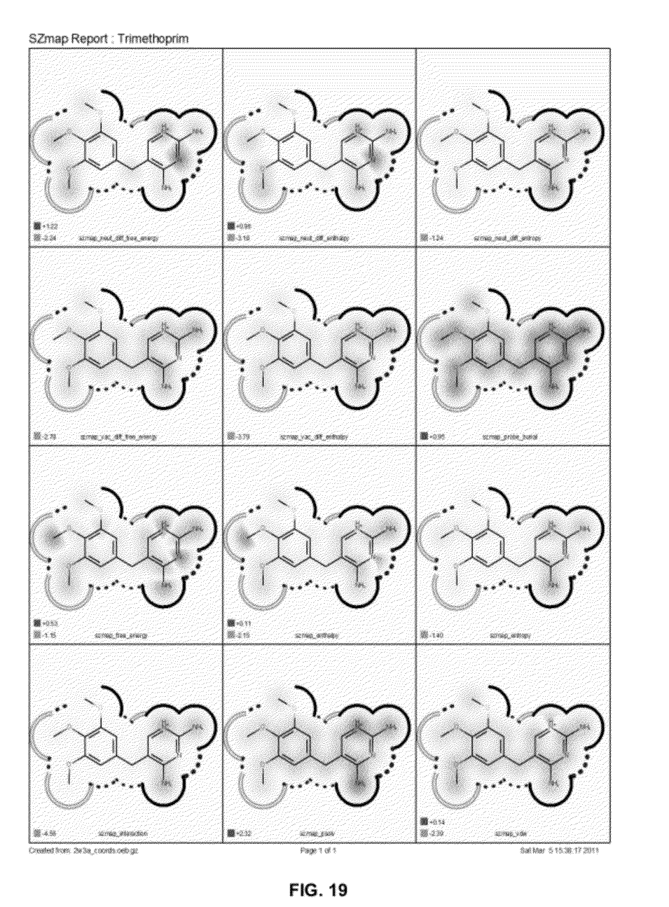

FIG. 19 shows a table of augmented structure diagrams (for the molecule of Example 5 (FIGS. 12A-12D), showing augmentations based on various properties of the molecule. Key determinants of molecular interaction are easy to see for each position in the table, as well as by comparison between each molecule.

### Example 11

### Exemplary Surface Styles

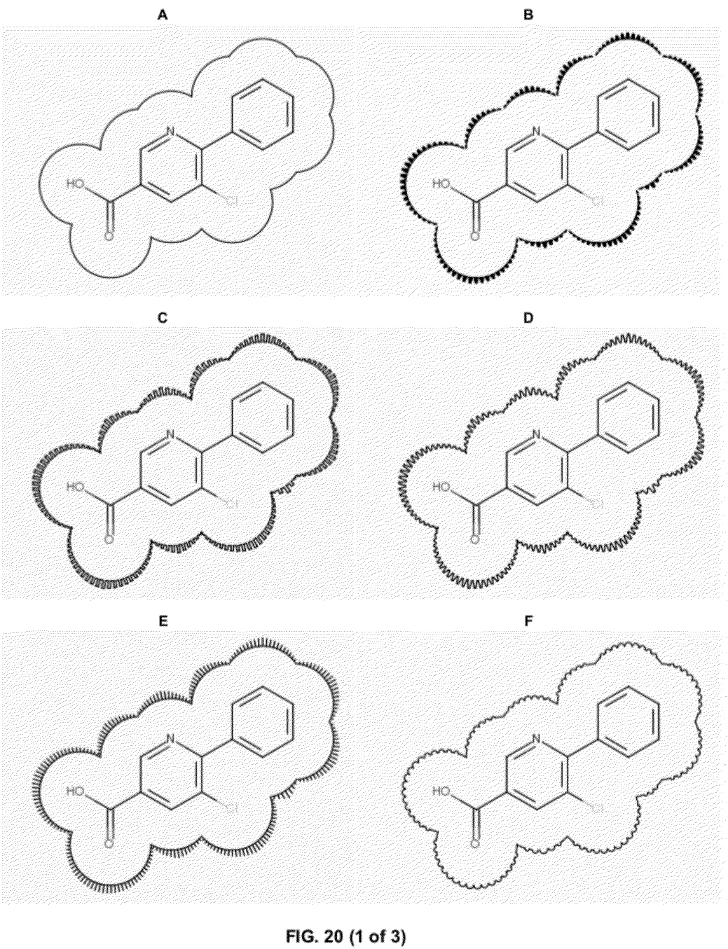

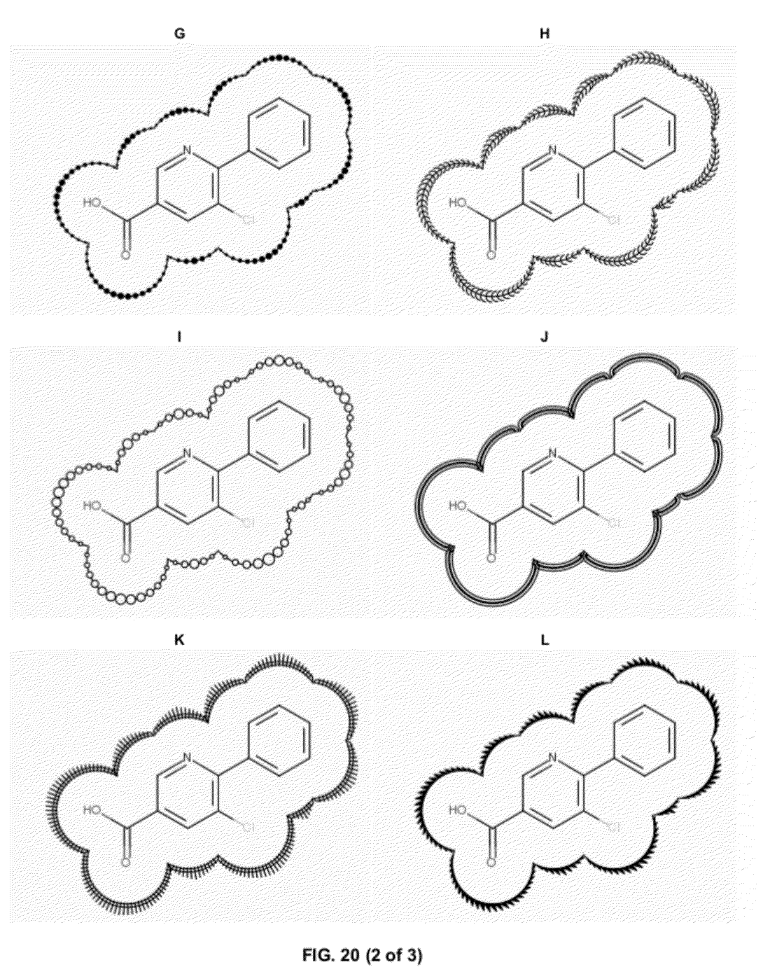

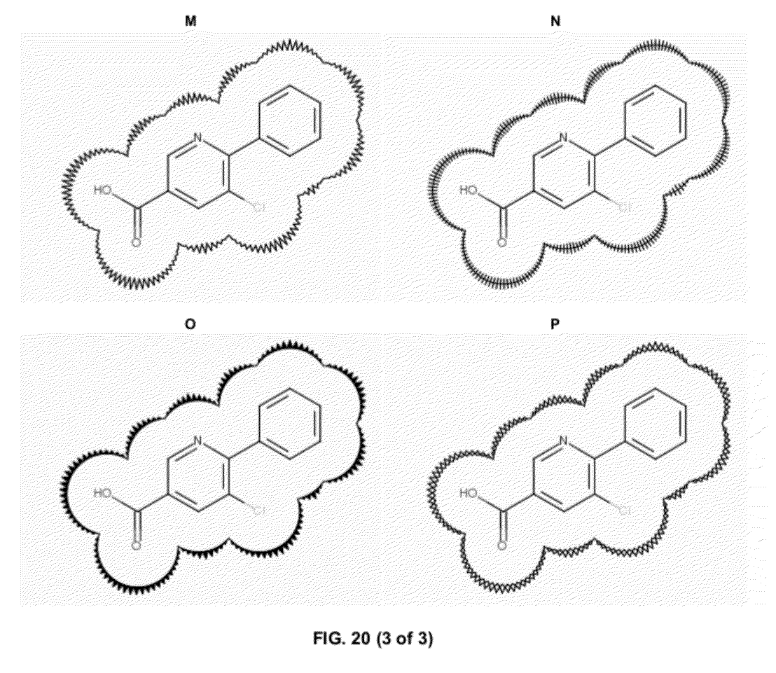

FIG. 20 illustrates a number of surface styles for an exemplary molecule, as follows:

Panel A: Default, simple arc style.

Panel B: “Brick Road” arc style.

Panel C: “Castle” arc style.

Panel D: “Cog” arc style.

Panel E: “Eye-lash” arc style.

Panel F: “Flower” arc style.

Panel G: “Necklace” arc style.

Panel H: “Olive Branch” arc style.

Panel I: “Pearls” arc style.

Panel J: “Race Track” arc style.

Panel K: “RailRoad” arc style.

Panel L: “Saw” arc style.

Panel M: “Simpson” arc style.

Panel N: “Stitch” arc style.

Panel O: “Sun” arc style.

Panel P: “Wreath” arc style.

It should be noted that in this example, as elsewhere herein, the name given to a particular style is purely descriptive and for convenience of reference, and is not to be taken to have an absolute meaning, such as from use elsewhere in the art. The form of the style in each case is defined by its appearance not by any linguistic terminology applied to it.

### Example 12

### Surface Arc Characterization

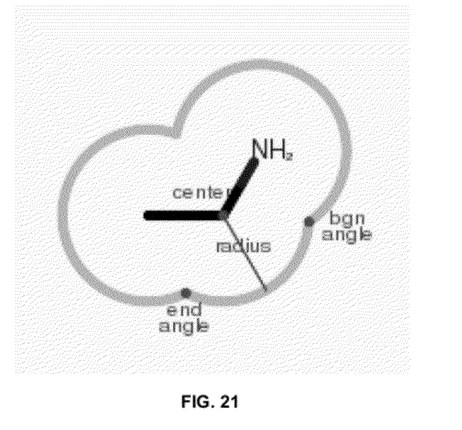

FIG. 21 illustrates core features of a surface arc. In FIG. 21 the arc parameters are illustrated for the amino-carbon atom in ethyl-amine.

Any surface arc depiction can be based on a small number of core parameters, assuming that the arc is an arc of a circle: specifically, a center of the circle, normally the location of the atom in the 2-D structure diagram; a radius for the arc, normally set to the bond length used in the 2-D structure diagram to which the arc is to be applied; and two angular positions on an imaginary circle centered on the atom: the two angular positions, a beginning angle, and an end angle, define respectively the start and end points of the arc. Arbitrarily, the 0° angular position on all circles can be set to be in the vertical/upright/“12 o'clock” position on the 2-D structure diagram.

### Example 13

### Circle Styles

FIG. 22 illustrates a number of circle styles, as may be applied to atom symbols, as follows:

Panel A: Default, simple style.

Panel B: “Brick Road” style.

Panel C: “Castle” style.

Panel D: “Cog” style.

Panel E: “Eye-lash” style.

Panel F: “Flower” style.

Panel G: “Necklace” style.

Panel H: “Olive Branch” style.

Panel I: “Pearls” style.

Panel J: “Race Track” style.

Panel K: “RailRoad Track” style.

Panel L: “Saw” style.

Panel M: “Simpson” style.

Panel N: “Stitch” style.

Panel O: “Sun” style.

Panel P: “Wreath” style.

Panel Q: “Alpha Rainbow” style.

Panel R: “Greek Key” style.

Aspects of the parameters that control display of the various circle styles of FIG. 22 are described in other Examples herein.

In general, the types of parameters that are available for a circle include, but are not limited to: circle radius, the pen style, whether the pattern is drawn facing inside or outside of the circle, the ratio of the pattern width (thickness in a radial direction) to the circle diameter, the angle between each instance of the pattern on the circle, and the angular size of each instance of the pattern on the circle.

### Example 14

### Arc Styles

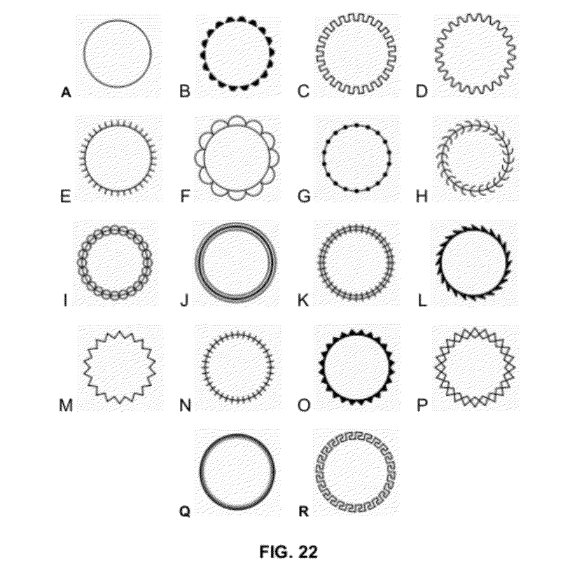

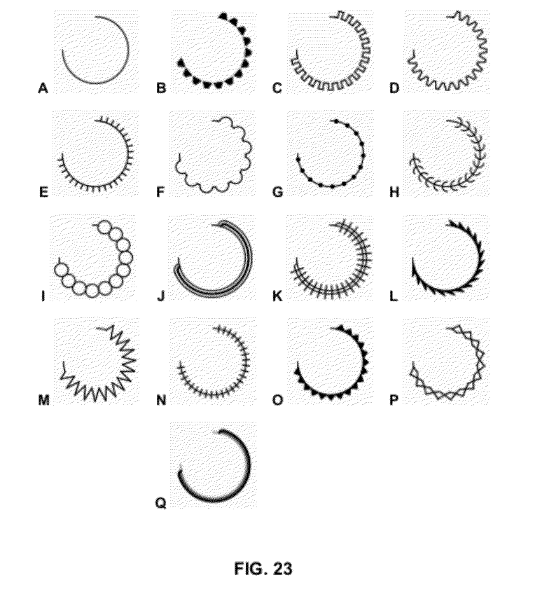

FIG. 23 illustrates a number of arc styles, as may be applied to an accessible surface of a molecule depicted in 2-D, as follows:

Panel A: Default, simple style.

Panel B: “Brick Road” style.

Panel C: “Castle” style.

Panel D: “Cog” style.

Panel E: “Eye-lash” style.

Panel F: “Flower” style.

Panel G: “Necklace” style.

Panel H: “Olive Branch” style.

Panel I: “Pearls” style.

Panel J: “Race Track” style.

Panel K: “RailRoad Track” style.

Panel L: “Saw” style.

Panel M: “Simpson” style.

Panel N: “Stitch” style.

Panel O: “Sun” style.

Panel P: “Wreath” style.

Panel Q: “Alpha Rainbow” style.

Aspects of creating the various arc styles of FIG. 23 are described in other Examples herein.

In general, the types of parameters that are available for an arc include, but are not limited to: circle radius, the pen style, whether the pattern is drawn facing inside or outside of the arc, the ratio of the pattern width (thickness in a radial direction) to the arc diameter, the angle between each instance of the pattern on the arc, and the angular size of each instance of the pattern on the arc. Additionally, where it is normally the case that a pattern repeats itself identically at all points on the circumference of a circle, for an arc this is not necessarily the case because it is desired to join arcs centered on different atoms smoothly. Thus for arcs, it is also possible to vary the thickness of the pattern from the end-points of the arc to the mid-point. It is also possible to specify a ‘boundary’ thickness for arcs, such that the pattern does not extend to each endpoint of an arc.

### Example 15

### Pattern Direction for Circles and Surface Arcs

Certain patterns for a circle or arc, as shown in FIGS. 22 and 23, can be oriented either inwardly or outwardly, by user choice.

Examples of inwardly-pointing designs for circle and arc are shown in FIG. 24A; exemplary outwardly-pointing designs in circles and arcs for the same patterns as in FIG. 24A, are shown in FIG. 24B.

### Example 16

### Parameters for “Brick Road” Circle and Surface Arc Style

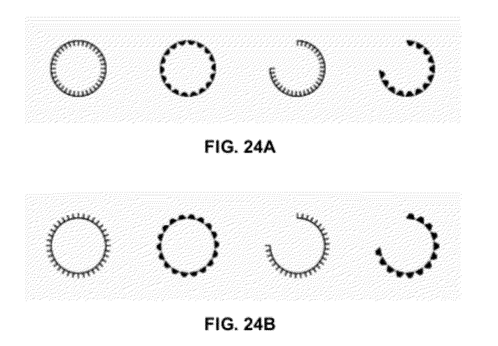

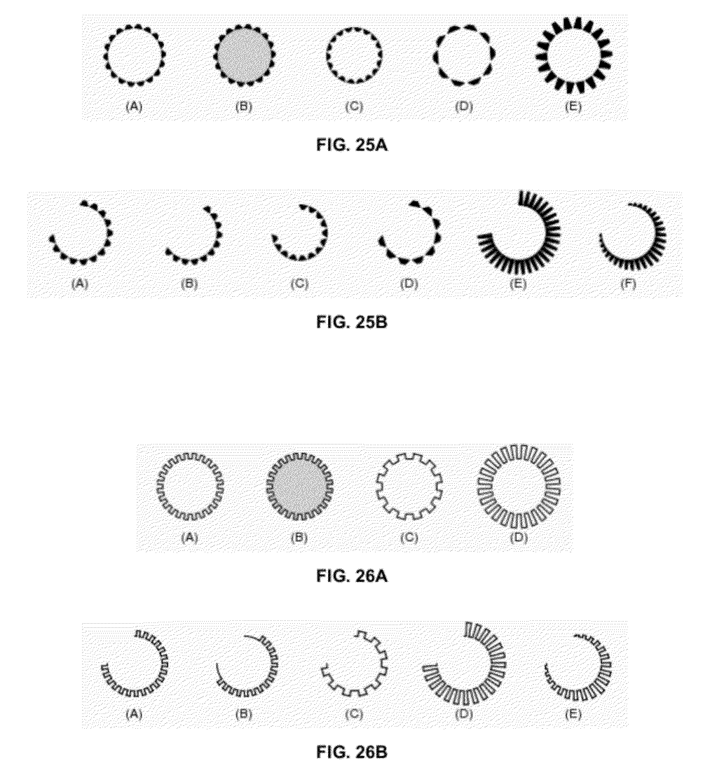

Certain aspects of variation for a circle or arc drawn in the Brick Road style are shown in FIGS. 25A and 25B, respectively. Each instance of the pattern is a solid trapezoid positioned with the longer of its two parallel sides on the circumference of the circle.

The parameters that admit of variation for both an arc and a complete circle include: the circle radius, the pen style, whether the pattern is drawn facing inside or outside of the circle, the ratio of the pattern width (thickness in a radial direction) to the circle diameter, and the angle between each instance of the pattern on the circle or arc.

Additionally, for a circle, the presence or absence of shading in the interior of the circle, and the color of the circle rim and interior are variables.

Panels A and B of FIG. 25A show different shading and coloring of the circle interior. Panels A and C of FIG. 25A differ in that the latter shows the pattern directed towards the interior of the circle. Panels A and D of FIG. 25A show different values of the angle between each instance of the pattern on the circle. Panels A and E of FIG. 25A show different values of the pattern width.

For the arc, it is also necessary to specify the angular positions for the beginning and end-points of the arc. If it is not desired that the Brick Road pattern extend all the way to the end points of the arc, an edge angular width can be specified as the difference between the end points of the arc and the points where the pattern of the arc starts. This is shown in Panel B of FIG. 25B.

Additionally, for an arc it is possible to specify a maximum and minimum value for the pattern width, so that the pattern starts with the minimum value at each end-point and rises to the maximum value halfway in between. This effect is illustrated in panel F of FIG. 25B.

### Example 17

### Parameters for “Castle” Circle and Surface Arc Style

Certain aspects of variation for a circle or arc drawn in the Castle style are shown in FIGS. 26A and 26B, respectively. Each instance of the pattern is an open rectangle positioned with its closed long side positioned tangentially and away from the circumference of the circle. The two parallel shorter sides extend radially from the circumference.

The parameters that admit of variation for both an arc and a complete circle include: the circle radius, the pen style, the ratio of the pattern width (thickness in a radial direction) to the circle diameter, and the angle between each instance of the pattern on the circle or arc.

Additionally, for a circle, the presence or absence of shading in the interior of the circle, and the color of the circle rim and interior are variables.

Panels A and B of FIG. 26A show different shading and coloring of the circle interior. Panels A and C of FIG. 26A show different values of the angle between each instance of the pattern on the circle. Panels A and D of FIG. 26A show different values of the pattern width.

For the arc, it is also necessary to specify the angular positions for the beginning and end-points of the arc. If it is not desired that the Castle pattern extend all the way to the end points of the arc, an edge angular width can be specified as the difference between the end points of the arc and the points where the pattern of the arc starts, as shown in panel B of FIG. 26B.

Additionally, for an arc it is possible to specify a maximum and minimum value for the pattern width, so that the pattern starts with the minimum value at each end-point and rises to the maximum value halfway in between. This effect is illustrated in panel E of FIG. 26B.

### Example 18

### Parameters for “Cog” Circle and Surface Arc Style

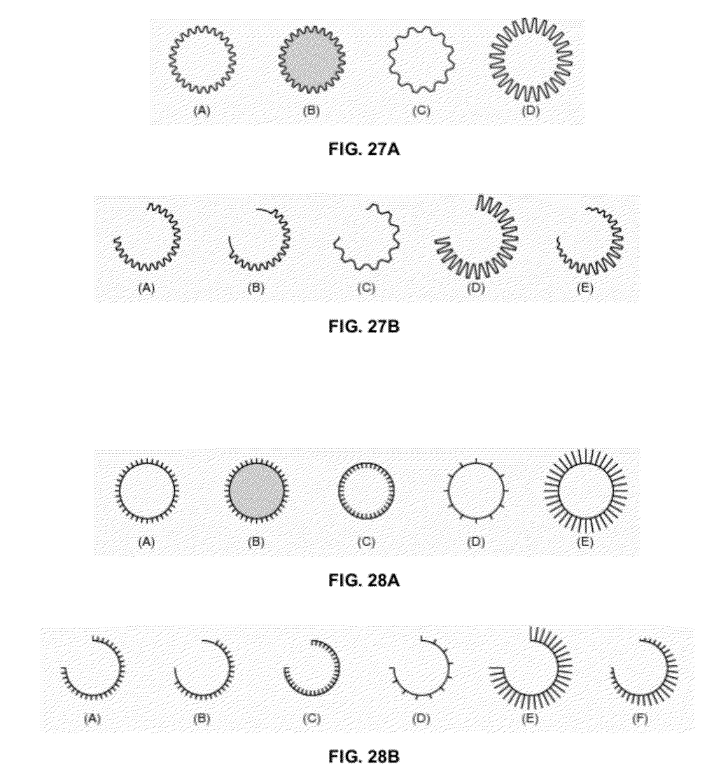

Certain aspects of variation for a circle or arc drawn in the Cog style are shown in FIGS. 27A and 27B, respectively. Each instance of the pattern is an open trapezoid positioned with the longer of its two parallel sides on the circumference of the circle

The parameters that admit of variation for both an arc and a complete circle drawn in the Cog style include: the circle radius, the pen style, the ratio of the pattern width (thickness in a radial direction) to the circle diameter, and the angle between each instance of the pattern on the circle or arc.

Additionally, for a circle, the presence or absence of shading in the interior of the circle, and the color of the circle rim and interior are variables.

Panels A and B of FIG. 27A show different shading and coloring of the circle interior. Panels A and C of FIG. 27A show different values of the angle between each instance of the pattern on the circle. Panels A and D of FIG. 27A show different values of the pattern width.

For the arc, it is also necessary to specify the angular positions for the beginning and end-points of the arc. If it is not desired that the Cog pattern extend all the way to the end points of the arc, an edge angular width can be specified as the difference between the end points of the arc and the points where the pattern of the arc starts, as shown in panel B of FIG. 27B.

Additionally, for an arc it is possible to specify a maximum and minimum value for the pattern width, so that the pattern starts with the minimum value at each end-point and rises to the maximum value halfway in between. This effect is illustrated in panel E of FIG. 27B.

### Example 19

### Parameters for “Eye-lash” Circle and Surface Arc Style

Certain aspects of variation for a circle or arc drawn in the Eye-lash style are shown in FIGS. 28A and 28B, respectively. Each instance of the pattern is a line projecting radially from the circumference of the circle.

The parameters that admit of variation for both an arc and a complete circle include: the circle radius, the pen style, whether the pattern is drawn facing inside or outside of the circle, the ratio of the pattern width (thickness in a radial direction) to the circle diameter, and the angle between each instance of the pattern on the circle or arc.

Additionally, for a circle, the presence or absence of shading in the interior of the circle, and the color of the circle rim and interior are variables.

Panels A and B of FIG. 28A show different shading and coloring of the circle interior. Panels A and C of FIG. 28A differ in that the latter shows the pattern directed towards the interior of the circle. Panels A and D of FIG. 28A show different values of the angle between each instance of the pattern on the circle. Panels A and E of FIG. 28A show different values of the pattern width.

For the arc, it is also necessary to specify the angular positions for the beginning and end-points of the arc. If it is not desired that the Eye Lash pattern extend all the way to the end points of the arc, an edge angular width can be specified as the difference between the end points of the arc and the points where the pattern of the arc starts. This is shown in Panel B of FIG. 28B.

Additionally, for an arc it is possible to specify a maximum and minimum value for the pattern width, so that the pattern starts with the minimum value at each end-point and rises to the maximum value halfway in between. This effect is shown in panel F of FIG. 28B.

### Example 20

### Parameters for “Flower” Circle and Surface Arc Style

Certain aspects of variation for a circle or arc drawn in the Flower style are shown in FIGS. 29A and 29B, respectively. Each instance of the pattern is a semi-circular arc projecting radially from, and centered on, the circumference of the circle.

The parameters that admit of variation for both an arc and a complete circle include: the circle radius, the pen style, the ratio of the pattern width (thickness in a radial direction) to the circle diameter, and the angle between each instance of the pattern on the circle or arc.

Additionally, for a circle, the presence or absence of shading in the interior of the circle, and the color of the circle rim and interior are variables.

Panels A and B of FIG. 29A show different shading and coloring of the circle interior. Panels A and C of FIG. 29A show different values of the pattern width.

For the arc, it is also necessary to specify the angular positions for the beginning and end-points of the arc. If it is not desired that the Flower pattern extend all the way to the end points of the arc, an edge angular width can be specified as the difference between the end points of the arc and the points where the pattern of the arc starts. This is shown in Panel B of FIG. 29B.

Additionally, for an arc it is possible to specify a maximum and minimum value for the pattern width, so that the pattern starts with the minimum value at each end-point and rises to the maximum value halfway in between. This effect is illustrated in panel E of FIG. 29B.

### Example 21

### Parameters for “Necklace” Circle and Surface Arc Style

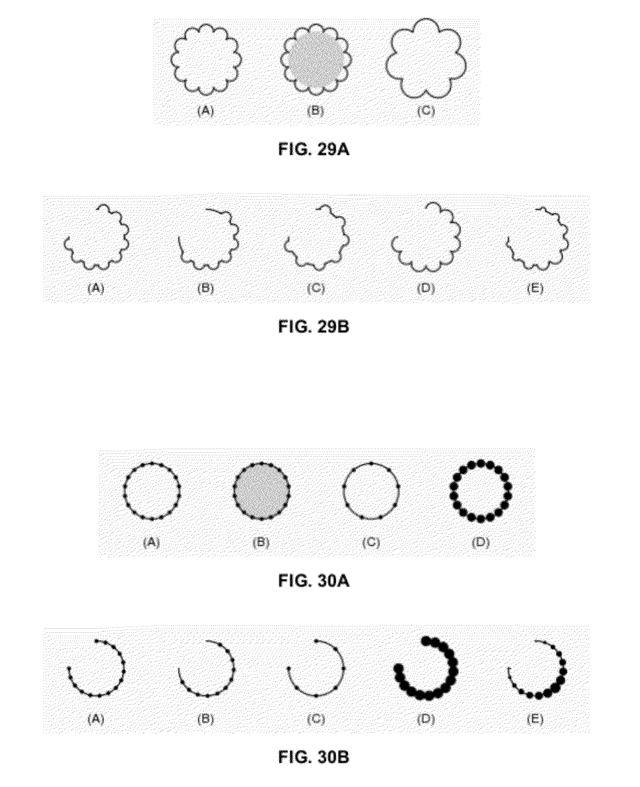

Certain aspects of variation for a circle or arc drawn in the Necklace style are shown in FIGS. 30A and 30B, respectively. Each instance of the pattern is a filled (solid) circular spot whose center is superimposed on the circumference of the circle.

The parameters that admit of variation for both an arc and a complete circle include: the circle radius, the pen style, the ratio of the pattern width (thickness in a radial direction) to the circle diameter, and the angle between each instance of the pattern on the circle or arc.

Additionally, for a circle, the presence or absence of shading in the interior of the circle, and the color of the circle rim and interior are variables.

Panels A and B of FIG. 30A show different shading and coloring of the circle interior. Panels A and C of FIG. 30A show different values of the angle between each instance of the pattern on the circle. Panels A and D of FIG. 30A show different values of the pattern width.

For the arc, it is also necessary to specify the angular positions for the beginning and end-points of the arc. If it is not desired that the Necklace pattern extend all the way to the end points of the arc, an edge angular width can be specified as the difference between the end points of the arc and the points where the pattern of the arc starts. This is shown in Panel B of FIG. 30B.

Additionally, for an arc it is possible to specify a maximum and minimum value for the pattern width, so that the pattern starts with the minimum value at each end-point and rises to the maximum value halfway in between. This effect is illustrated in panel E of FIG. 30B.

### Example 22

### Parameters for “Olive Branch” Circle and Surface Arc Style

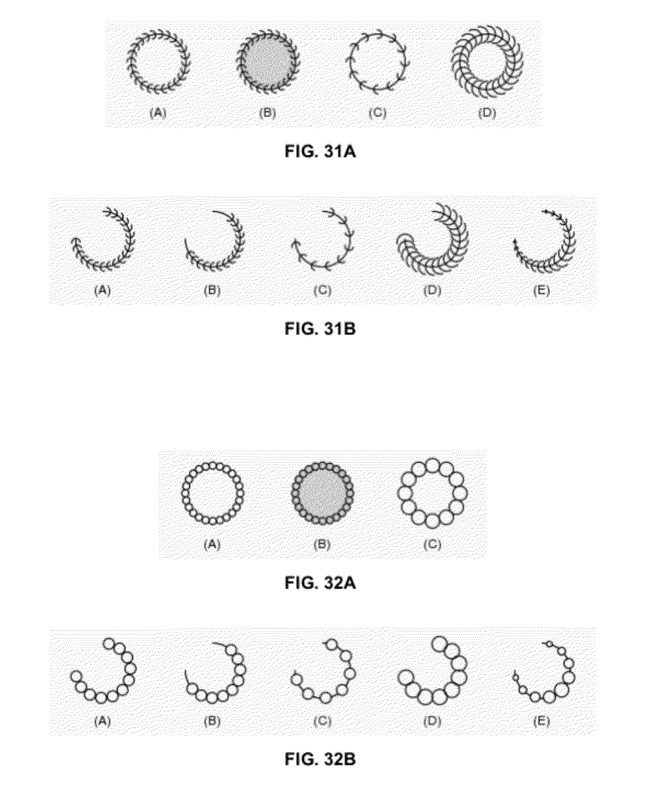

Certain aspects of variation for a circle or arc drawn in the Olive Branch style are shown in FIGS. 31A and 31B, respectively. Each instance of the pattern is a curved line superimposed on, and orthogonal to, the circumference of the circle. All instances of the pattern are convex in the same sense (clockwise/counter-clockwise) around the circumference.

The parameters that admit of variation for both an arc and a complete circle include: the circle radius, the pen style, the ratio of the pattern width (thickness in a radial direction) to the circle diameter, the handedness (whether the pattern faces clockwise or counter-clockwise, and the angle between each instance of the pattern on the circle or arc.

Additionally, for a circle, the presence or absence of shading in the interior of the circle, and the color of the circle rim and interior are variables.

Panels A and B of FIG. 31A show different shading and coloring of the circle interior. Panels A and C of FIG. 31A show different values of the angle between each instance of the pattern on the circle. Panels A and D of FIG. 31A show different values of the pattern width.

For the arc, it is also necessary to specify the angular positions for the beginning and end-points of the arc. If it is not desired that the Olive Branch pattern extend all the way to the end points of the arc, an edge angular width can be specified as the difference between the end points of the arc and the points where the pattern of the arc starts. This is shown in Panel B of FIG. 31B.

Additionally, for an arc it is possible to specify a maximum and minimum value for the pattern width, so that the pattern starts with the minimum value at each end-point and rises to the maximum value halfway in between. This effect is illustrated in panel E of FIG. 31B.

### Example 23

### Parameters for “Pearls” Circle and Surface Arc Style

Certain aspects of variation for a circle or arc drawn in the Pearls style are shown in FIGS. 32A and 32B, respectively. Each instance of the pattern is an open circle (ring) centered on, and obscuring, the circumference of the circle.

The parameters that admit of variation for both an arc and a complete circle include: the circle radius, the pen style, the ratio of the pattern width (thickness in a radial direction) to the circle diameter, and the angle between each instance of the pattern on the circle or arc.

Additionally, for a circle, the presence or absence of shading in the interior of the circle (and/or the patterns), and the color of the circle rim and interior are variables.

Panels A and B of FIG. 32A show different shading and coloring of the circle interior. Panels A and C of FIG. 32A show different values of the pattern width.

For the arc, it is also necessary to specify the angular positions for the beginning and end-points of the arc. If it is not desired that the Pearls pattern extend all the way to the end points of the arc, an edge angular width can be specified as the difference between the end points of the arc and the points where the pattern of the arc starts. This is shown in Panel B of FIG. 32B.

Additionally, for an arc it is possible to specify a maximum and minimum value for the pattern width, so that the pattern starts with the minimum value at each end-point and rises to the maximum value halfway in between. This effect is illustrated in panel E of FIG. 32B.

### Example 24

### Parameters for “Race Track” Circle and Surface Arc Style

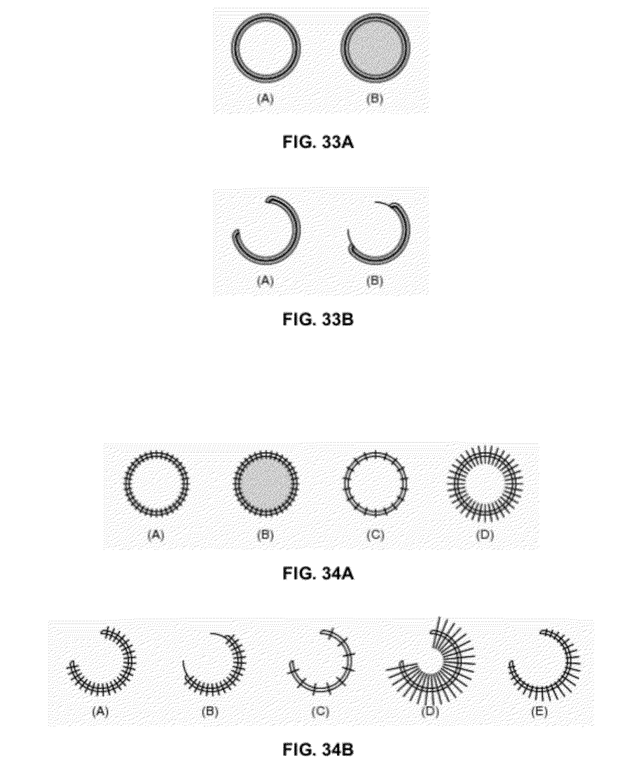

Certain aspects of variation for a circle or arc drawn in the Race Track style are shown in FIGS. 33A and 33B, respectively. The pattern comprises three concentric circumferential lines, the middle of which is thicker than the two on the interior and exterior of the circle or arc.

The parameters that admit of variation for both an arc and a complete circle include: the circle radius, and the pen style.

Additionally, for a circle, the presence or absence of shading in the interior of the circle, and the color of the circle rim and interior are variables. Panels A and B of FIG. 33A show different shading and coloring of the circle interior.

For the arc, it is also necessary to specify the angular positions for the beginning and end-points of the arc. If it is not desired that the Race Track pattern extend all the way to the end points of the arc, an edge angular width can be specified as the difference between the end points of the arc and the points where the pattern of the arc starts, as shown in panel B of FIG. 33B.

### Example 25

### Parameters for “RailRoad Track” Circle and Surface Arc Style

Certain aspects of variation for a circle or arc drawn in the Railroad Track style are shown in FIGS. 34A and 34B, respectively. The pattern comprises two concentric circumferential lines of equal thickness that replace the rim of the circle or arc. Each instance of the pattern is a line projecting radially and crossing the two concentric circumferential lines.

The parameters that admit of variation for both an arc and a complete circle include: the circle radius, the pen style, the ratio of the pattern width (thickness in a radial direction of the radial lines) to the circle diameter, and the angle between each instance of the radial lines of the pattern on the circle or arc.

Additionally, for a circle, the presence or absence of shading in the interior of the circle (and/or the patterns), and the color of the circle rim and interior are variables.

Panels A and B of FIG. 34A show different shading and coloring of the circle interior. Panels A and C of FIG. 34A show different values of the angle between each instance of the pattern on the circle. Panels A and D of FIG. 34A show different values of the pattern width.

For the arc, it is also necessary to specify the angular positions for the beginning and end-points of the arc. If it is not desired that the RailRoad Track pattern extend all the way to the end points of the arc, an edge angular width can be specified as the difference between the end points of the arc and the points where the pattern of the arc starts. This is shown in Panel B of FIG. 34B.

Additionally, for an arc it is possible to specify a maximum and minimum value for the pattern width, so that the pattern starts with the minimum value at each end-point and rises to the maximum value halfway in between. This effect is illustrated in panel E of FIG. 34B.

### Example 26

### Parameters for “Saw” Circle and Surface Arc Style

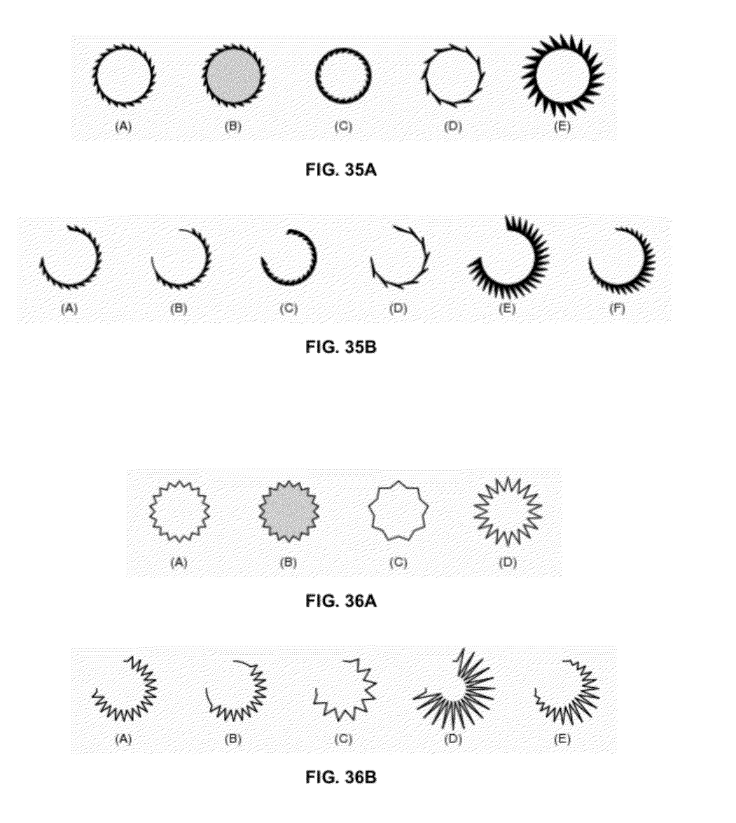

Certain aspects of variation for a circle or arc drawn in the Saw style are shown in FIGS. 35A and 35B, respectively. Each instance of the pattern is a filled (solid) triangle projecting at an acute angle to the local tangent on the circumference.

The parameters that admit of variation for both an arc and a complete circle include: the circle radius, the pen style, whether the pattern is drawn facing inside or outside of the circle, the ratio of the pattern width (thickness in a radial direction) to the circle diameter, and the angle occupied by each instance of the pattern on the circle or arc.

Additionally, for a circle, the presence or absence of shading in the interior of the circle, and the color of the circle rim and interior are variables.

Panels A and B of FIG. 35A show different shading and coloring of the circle interior. Panels A and C of FIG. 35A differ in that the latter shows the pattern directed towards the interior of the circle. Panels A and D of FIG. 35A show different values of the angle occupied by each instance of the pattern on the circle. Panels A and E of FIG. 35A show different values of the pattern width.

For the arc, it is also necessary to specify the angular positions for the beginning and end-points of the arc. If it is not desired that the Saw pattern extend all the way to the end points of the arc, an edge angular width can be specified as the difference between the end points of the arc and the points where the pattern of the arc starts. This is shown in Panel B of FIG. 35B.

Additionally, for an arc it is possible to specify a maximum and minimum value for the pattern width, so that the pattern starts with the minimum value at each end-point and rises to the maximum value halfway in between. This effect is illustrated in panel F of FIG. 35B.

### Example 27

### Parameters for “Simpson” Circle and Surface Arc Style

Certain aspects of variation for a circle or arc drawn in the Simpson style are shown in FIGS. 36A and 36B, respectively. Each instance of the pattern is an open triangle positioned with its open side on the circumference of the circle. The two other sides extend outwardly from the circumference. The resulting shape, although based on a circle, resembles a star-shaped polygon.

The parameters that admit of variation for both an arc and a complete circle include: the circle radius, the pen style, the ratio of the pattern width (thickness in a radial direction) to the circle diameter, and the angle occupied by each instance of the pattern on the circle or arc.

Additionally, for a circle, the presence or absence of shading in the interior of the circle, and the color of the circle rim and interior are variables.

Panels A and B of FIG. 36A show different shading and coloring of the circle interior. Panels A and C of FIG. 36A show different values of the angle occupied by each instance of the pattern on the circle. Panels A and D of FIG. 36A show different values of the pattern width.

For the arc, it is also necessary to specify the angular positions for the beginning and end-points of the arc. If it is not desired that the Simpson pattern extend all the way to the end points of the arc, an edge angular width can be specified as the difference between the end points of the arc and the points where the pattern of the arc starts, as shown in panel B of FIG. 36B.

Additionally, for an arc it is possible to specify a maximum and minimum value for the pattern width, so that the pattern starts with the minimum value at each end-point and rises to the maximum value halfway in between. This effect is illustrated in panel E of FIG. 36B.

### Example 28

### Parameters for “Stitch” Circle and Surface Arc Style

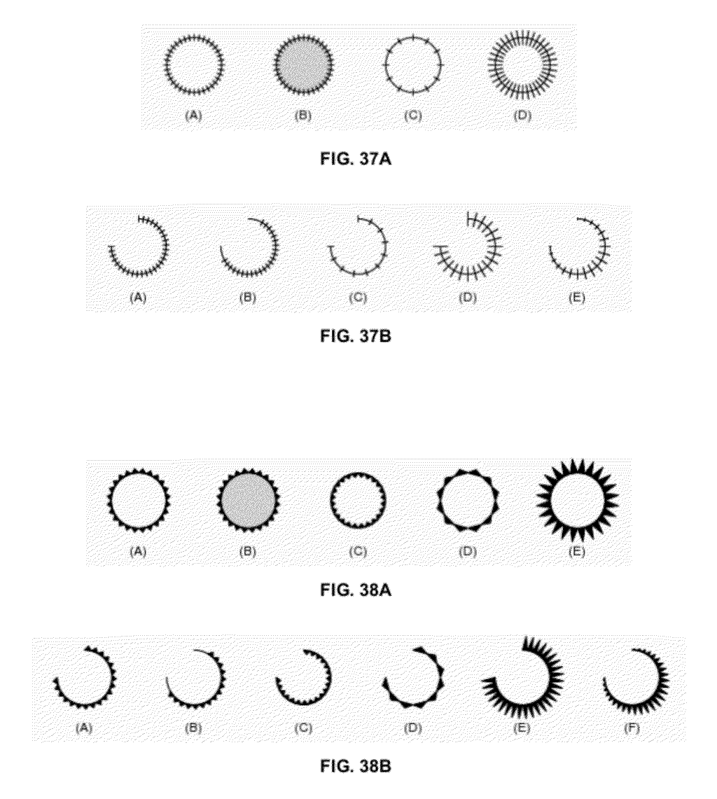

Certain aspects of variation for a circle or arc drawn in the Stitch style are shown in FIGS. 37A and 37B, respectively. Each instance of the pattern is a line projecting radially and crossing the circumference of the circle or arc.

The parameters that admit of variation for both an arc and a complete circle include: the circle radius, the pen style, the ratio of the pattern width (thickness in a radial direction of the radial lines) to the circle diameter, and the angle between each instance of the radial lines of the pattern on the circle or arc.

Additionally, for a circle, the presence or absence of shading in the interior of the circle (and/or the patterns), and the color of the circle rim and interior are variables.

Panels A and B of FIG. 37A show different shading and coloring of the circle interior. Panels A and C of FIG. 37A show different values of the angle between each instance of the pattern on the circle. Panels A and D of FIG. 37A show different values of the pattern width.

For the arc, it is also necessary to specify the angular positions for the beginning and end-points of the arc. If it is not desired that the Stitch pattern extend all the way to the end points of the arc, an edge angular width can be specified as the difference between the end points of the arc and the points where the pattern of the arc starts. This is shown in Panel B of FIG. 37B.

Additionally, for an arc it is possible to specify a maximum and minimum value for the pattern width, so that the pattern starts with the minimum value at each end-point and rises to the maximum value halfway in between. This effect is illustrated in panel E of FIG. 37B.

### Example 29

### Parameters for “Sun” Circle and Surface Arc Style

Certain aspects of variation for a circle or arc drawn in the Sun style are shown in FIGS. 38A and 38B, respectively. Each instance of the pattern is a filled (solid) isoceles triangle whose vertical axis projects radially from the circumference. The base of the triangle lies on the circumference of the circle.

The parameters that admit of variation for both an arc and a complete circle include: the circle radius, the pen style, whether the pattern is drawn facing inside or outside of the circle, the ratio of the pattern width (thickness in a radial direction) to the circle diameter, and the angle occupied by each instance of the pattern on the circle or arc.

Additionally, for a circle, the presence or absence of shading in the interior of the circle, and the color of the circle rim and interior are variables.

Panels A and B of FIG. 38A show different shading and coloring of the circle interior. Panels A and C of FIG. 38A differ in that the latter shows the pattern directed towards the interior of the circle. Panels A and D of FIG. 38A show different values of the angle occupied by each instance of the pattern on the circle. Panels A and E of FIG. 38A show different values of the pattern width.

For the arc, it is also necessary to specify the angular positions for the beginning and end-points of the arc. If it is not desired that the Sun pattern extend all the way to the end points of the arc, an edge angular width can be specified as the difference between the end points of the arc and the points where the pattern of the arc starts. This is shown in Panel B of FIG. 38B.

Additionally, for an arc it is possible to specify a maximum and minimum value for the pattern width, so that the pattern starts with the minimum value at each end-point and rises to the maximum value halfway in between. This effect is illustrated in panel F of FIG. 38B.

### Example 30

### Parameters for “Wreath” Circle and Surface Arc Style

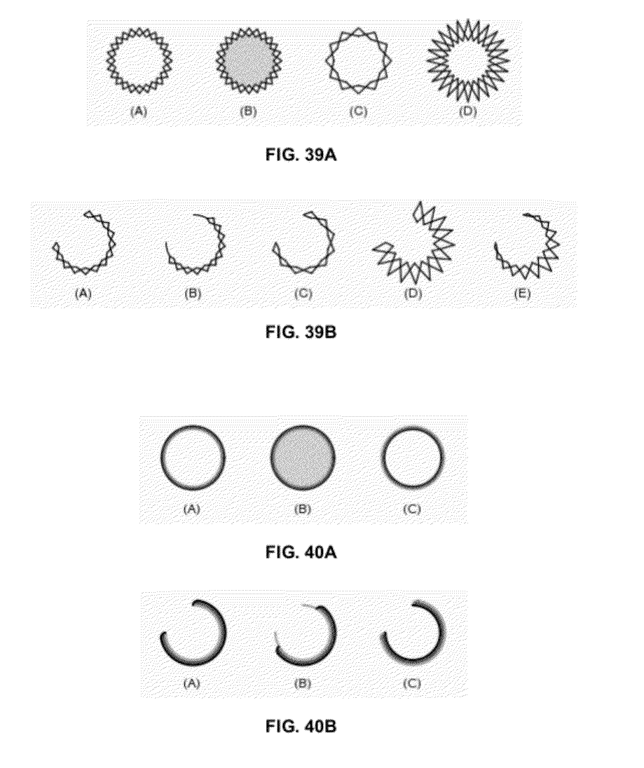

Certain aspects of variation for a circle or arc drawn in the Wreath style are shown in FIGS. 39A and 39B, respectively. Each instance of the pattern is comprised of two overlapping triangles of different heights.

The parameters that admit of variation for both an arc and a complete circle include: the circle radius, the pen style, the ratio of the pattern width (thickness in a radial direction) to the circle diameter, and the angle occupied by each instance of the pattern on the circle or arc.

Additionally, for a circle, the presence or absence of shading in the interior of the circle, and the color of the circle rim and interior are variables.

Panels A and B of FIG. 39A show different shading and coloring of the circle interior. Panels A and C of FIG. 39A show different values of the angle occupied by each instance of the pattern on the circle. Panels A and D of FIG. 39A show different values of the pattern width.

For the arc, it is also necessary to specify the angular positions for the beginning and end-points of the arc. If it is not desired that the Wreath pattern extend all the way to the end points of the arc, an edge angular width can be specified as the difference between the end points of the arc and the points where the pattern of the arc starts. This is shown in Panel B of FIG. 39B.

Additionally, for an arc it is possible to specify a maximum and minimum value for the pattern width, so that the pattern starts with the minimum value at each end-point and rises to the maximum value halfway in between. This effect is illustrated in panel F of FIG. 39B.

### Example 31

### Parameters for Alpha-Rainbow Circle and Surface Arc Style

Certain aspects of variation for a circle or arc drawn in the Alpha Rainbow style are shown in FIGS. 40A and 40B, respectively.

The parameters that admit of variation for both an arc and a complete circle include: the circle radius, the pen style, presence or absence of shading in the interior of the circle, color of the circle rim and interior, and whether the pattern is drawn facing inside or outside of the circle. Panels A and C of FIG. 40A illustrate the difference between positioning the pattern facing inward or outward.

For the arc, it is also necessary to specify the angular positions for the beginning and end-points of the arc. If it is not desired that the rainbow pattern extend all the way to the end points of the arc, an edge angular width can be specified as the difference between the end points of the arc and the points where the pattern of the arc starts. This effect is illustrated in panel B of FIG. 40B.

### Example 32

### Parameters for Greek Key Circle Style

Certain aspects of variation for a circle drawn in the Greek Key style are shown in FIG. 41. Each instance of the pattern is an L-shaped outline projecting radially away from the center of the circle.

The parameters that admit of variation for a complete circle include: the circle radius, the pen style, the presence or absence of shading in the interior of the circle, the color of the circle rim and interior, the ratio of the pattern width (thickness in a radial direction) to the circle diameter, and the angle between each instance of the pattern on the circle.

Panels A and B of FIG. 41 show different shading and coloring of the circle interior. Panels A and C of FIG. 41 show different values of the angle between each instance of the pattern. Panels A and D of FIG. 41 show different values of the pattern width.

Although not explicitly shown herein the Greek Key style is also applicable to a surface arc, and its form may be varied according to use of parameters similar to those described for other arc styles herein.

### Example 33

### Comparison of Molecular Surfaces

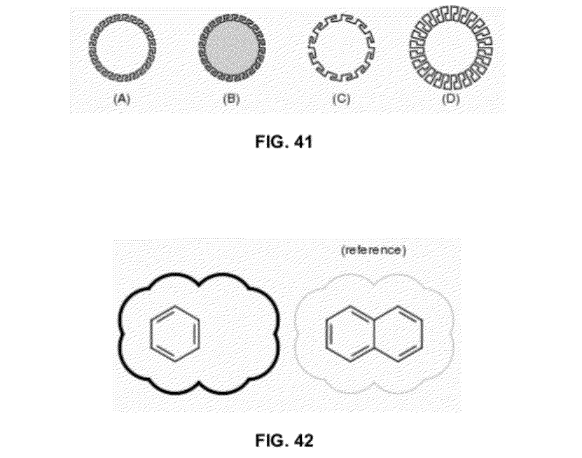

FIG. 42 shows how the surface generated for one molecule, the ‘reference’ molecule, shown at right of the figure, can be superimposed on the 2-D diagram for a second molecule, shown at left of the figure.

In FIG. 42, the surface is shown drawn with the default arc style; the superimposition can, of course, be carried out with any of the other surface and arc styles described herein.

### Example 34

### Illustrating Fitting of Overlapping Molecules

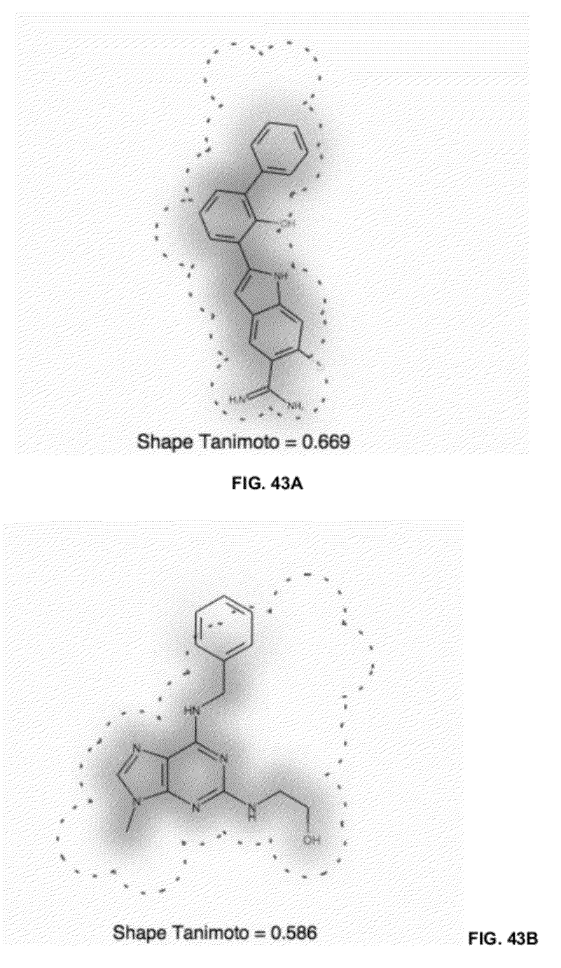

The augmentation of 2D diagrams can be used to show aspects of 3D shape matching. Examples, for two different molecule/reference pairs are shown in FIGS. 43A and 43B.

In each image, the accessible surface shown is actually the 2D surface from a reference image, but superimposed on a second ligand structure so that the areas where the second ligand misses the reference ligand can clearly be seen. Additionally, the background field in each image goes even further to show the per-atom overlap of the second ligand with the reference ligand. Fit atoms that don't have any “field” around them are atoms that don't overlap with the reference ligand in each case.

The example with a Shape Tanimoto coefficient of 0.669 shows a ligand-reference pair in which the ligand overlaps with a substantial portion of the reference (it is akin to being an exact substructure) but misses one section of the reference (at the top of the diagram, the empty space).

The example with a Shape Tanimoto coefficient of 0.586 shows a ligand-reference pair in which the ligand overlaps with a portion of the reference but additionally contains a pendant group that has no overlap. The empty space area indicates a third region in which the ligand misses overlap with the reference.

In order to effectively align the 2D representations of a ligand and reference, based on a known best-fit 3D overlap, it is normally necessary to modify the default 2D layout algorithm (which is typically based on generating the most extended layout form). In general, the 2D layout for such pairs must ensure a close correspondence in 2D between pairs of atoms that are also closely aligned in 3D.

The foregoing description is intended to illustrate various aspects of the instant technology. It is not intended that the examples presented herein limit the scope of the appended claims. The invention now being fully described, it will be apparent to one of ordinary skill in the art that many changes and modifications can be made thereto without departing from the spirit or scope of the appended claims.

What is claimed:

1. A method of displaying a molecular structure, the method comprising:
adding a set of graphical elements to a 2D representation of a molecular structure, thereby creating an augmented representation of the molecular structure; and
causing the augmented representation to be displayed to a user,
wherein the 2D representation comprises a graph in which each edge in the graph corresponds to a chemical bond in the molecular structure, and each node in the graph corresponds to an atom in the molecular structure, and
wherein the set of graphical elements includes one or more elements selected from:
an accessible surface contour around the graph or a part of the graph;
a background shading or color scheme behind the graph or a part of the graph;
a highlight applied to a discrete set of nodes and edges in the graph;
an atom symbol applied to one or more nodes in the graph; and
a bond symbol applied to one or more edges in the graph,
wherein each element in the set of graphical elements comprises a selectable style,
and at least one parameter having a user-defined value;
wherein the method is carried out on a computer.

2. The method of claim 1, wherein the 2D representation remains visible to a user after the set of graphical elements has been added to it.

3. The method of claim 1, wherein the accessible surface contour comprises a contiguous set of arcs, wherein each arc is centered on a node in the graph.

4. The method of claim 3, wherein each arc has a selectable style to denote an atomic environment selected from the group consisting of: void, solvent, and trapped solvent.

5. The method of claim 4, wherein the selectable style for each atomic environment has a different pattern.

6. The method of claim 5, wherein the parameter for each selectable style for an arc is a user-definable scaling factor to scale the pattern of the arc proportionally to a distance between the atom and a nearby protein surface.

7. The method of claim 1, wherein the background shading or color scheme comprises a parameter whose value can vary between two endpoints of a range, and whose value determines the shade of the color that is displayed.

8. The method of claim 7, wherein the parameter denotes a physical property, calculable for each atom in the molecular structure, and the color varies continuously according to a mapping onto values of the parameter.

9. The method of claim 1, wherein the highlight comprises a ball and stick pattern overlaying a contiguous set of nodes and edges in the graph.

10. The method of claim 1, wherein each atom symbol has a selectable style to denote a type of atom.

11. The method of claim 10, wherein each selectable style for an atom symbol has a different pattern.

12. The method of claim 11, wherein the parameter for each pattern includes a choice of color.

13. A computing apparatus, comprising:
a processor;
a memory;
an input; and
a display, wherein the processor, memory, input, and display are connected by at least one bus, and wherein the processor is configured to execute instructions for:
adding a set of graphical elements to a 2D representation of a molecular structure, thereby creating an augmented representation of the molecular structure; and
causing the augmented representation to be displayed to a user,
wherein the 2D representation comprises a graph in which each edge corresponds to a chemical bond in the molecular structure, and each node corresponds to an atom in the molecular structure, and
wherein the set of graphical elements includes one or more elements selected from:
an accessible surface contour around the graph or a part of the graph;
a background shading or color scheme behind the graph or a part of the graph;
a highlight applied to a discrete set of nodes and edges in the graph;
an atom symbol applied to one or more nodes in the graph; and
a bond symbol applied to one or more edges in the graph,
wherein each element in the set of graphical elements comprises a selectable style, and at least one parameter having a user-defined value.

14. A computer program product, comprising:
a computer readable medium configured with processor-executable instructions for:
adding a set of graphical elements to a 2D representation of a molecular structure, thereby creating an augmented representation of the molecular structure; and
causing the augmented representation to be displayed to a user,
wherein the 2D representation comprises a graph in which each edge corresponds to a chemical bond in the molecular structure, and each node corresponds to an atom in the molecular structure, and
wherein the set of graphical elements includes one or more elements selected from:
an accessible surface contour around the graph or a part of the graph;
a background shading or color scheme behind the graph or a part of the graph;
a highlight applied to a discrete set of nodes and edges in the graph;
an atom symbol applied to one or more nodes in the graph; and
a bond symbol applied to one or more edges in the graph,
wherein each element in the set of graphical elements comprises a selectable style, and at least one user-defined parameter.

15. A computer program product, comprising:
a computer readable medium configured with a kit of processor-executable instructions for augmenting a 2D representation of a chemical structure, wherein the kit comprises:
instructions for adding an accessible surface contour around the graph or a part of the graph;
instructions for adding a background shading or color scheme behind the graph or a part of the graph;
instructions for highlighting a discrete set of nodes and edges in the graph;
instructions for inserting an atom symbol at one or more nodes in the graph; and
instructions for inserting a bond symbol to one or more edges in the graph,
wherein the kit is configured to provide control by a user, and the instructions are executed at the choice of the user.
